(19) United States
(12) Patent Application Publication
(10) Pub. No.: US 2026/0087095 A1
(43) Pub. Date: Mar. 26, 2026

(54) CORRECTION VALUE CALCULATION METHOD, CORRECTION VALUE CALCULATION PROGRAM, CORRECTION VALUE CALCULATION APPARATUS, AND ENCODER

(71) Applicant: MITUTOYO CORPORATION, Kawasaki (JP)

(72) Inventor: Tetsuro Kiriyama, Kanagawa (JP)

(21) Appl. No.: 19/333,620

(22) Filed: Sep. 19, 2025

(30) Foreign Application Priority Data
Sep. 25, 2024 (JP) 2024-166767

(51) Int. Cl. G06F 17/16; G06F 17/11

(52) U.S. Cl. CPC G06F 17/16; G06F 17/11

(57) ABSTRACT

A correction value calculation method that calculates correction values to correct the kth harmonic component in the 2-phase sinusoidal signals (X, Y) output by the encoder are calculated. The correction value calculation method includes: a polar coordinate calculation step for calculating, for N phase angles θi and Lissajous radii Ri corresponding to each phase angle θi in a Lissajous waveform drawn by the 2-phase sinusoidal signals, a squared radius Ri2, which is the square of the Lissajous radius Ri corresponding to each phase angle θi; and a correction value calculation step for obtaining the correction values from coefficients obtained in an approximate expression model representing the squared radius R2 of the 2-phase sinusoidal signals containing kth harmonic component. The coefficients of the approximate expression model are determined by the least-squares method, and the resulting correction values are cumulatively added.

### CROSS-REFERENCE TO RELATED APPLICATION

This non-provisional application claims priority under 35 U.S.C. § 119(a) from Japanese Patent Application No. 2024-166767, filed on Sep. 25, 2024, the entire contents of which are incorporated herein by reference.

### BACKGROUND

### Technical Field

The present invention relates to a correction value calculation method, a correction value calculation program, a correction value calculation apparatus, and an encoder for correcting 2-phase sinusoidal signals.

### Background Art

Conventionally, methods for correcting errors such as an offset error, an amplitude ratio error, and a phase difference error in the 2-phase sinusoidal signals output by the encoder are known. For more accurate interpolation correction, in addition to correcting these errors, it is important to reduce higher harmonics of the 2-phase sinusoidal signal.

For example, the JP 2008-232649A discloses a method for correcting a 2nd harmonic, which is a high-order harmonic. When the 2nd harmonic is included in the 2-phase sinusoidal signal, correction values can be obtained by performing Fourier analysis using the characteristic that the Lissajous radius changes at λ/3 cycles.

Here, the electromagnetic inductive type encoder requires more time for sampling than the photoelectric type encoder because it detects displacement by applying an AC signal. In addition, in low-power consumption encoders, the sampling rate may be suppressed. Encoders with such a low sampling rate may not be able to sample around desired points (e.g., zero-crossing points or points where the Lissajous waveform intersects y=x or y=−x), and errors may not be sufficiently reduced.

Moreover, when obtaining correction values for high-order harmonic correction using Fourier analysis as shown in JP 2008-232649A, there is a problem that Fourier analysis is difficult when the sampling data has unequal pitches. In addition, there is a problem that detection errors may become large when the number of samples is small.

### SUMMARY OF THE INVENTION

### Problems to be Solved by the Invention

In view of these circumstances, one aspect of the present invention is to provide a correction value calculation method, a correction value calculation program, and a correction value calculation apparatus that can efficiently and accurately calculate correction values for high-order harmonics of interpolation errors in 2-phase sinusoidal signals by a simple method, and to provide an encoder equipped with such a correction value calculation apparatus.

### Means for Solving the Problems

To solve the above problem, the correction value calculation method according to an aspect of the present invention calculates correction values to correct the kth harmonic component in 2-phase sinusoidal signals (X, Y) output by an encoder. The correction value calculation method includes: a polar coordinate calculation step for calculating, for N phase angles θᵢ and Lissajous radii Rᵢ corresponding to each phase angle θᵢ in a Lissajous waveform drawn by the 2-phase sinusoidal signals, a squared radius Rᵢ², which is the square of the Lissajous radius Rᵢ corresponding to each phase angle θᵢ; and a correction value calculation step for obtaining the correction values from coefficients obtained in an approximate expression model representing the squared radius R² of the 2-phase sinusoidal signals containing kth harmonic component. In the correction value calculation step, the coefficients of the approximate expression model are determined by the least squares method, and the resulting correction values are cumulatively added as correction residuals.

### BRIEF DESCRIPTION OF THE DRAWINGS

FIG. 1 is a block diagram showing the basic configuration of the correction value calculation apparatus 1 of the first embodiment together with an encoder detection unit 11 and a wide-range phase angle calculation unit 50 in the encoder 10.

FIG. 2 is a flowchart showing the procedure of the correction value calculation process in the first embodiment.

FIG. 3 is a block diagram showing a correction value calculation apparatus 1a according to the second embodiment.

FIG. 4 is a flowchart showing the procedure of the correction value calculation process in the second embodiment.

FIGS. 5A and 5B are graphs showing the 2-phase sinusoidal signals before correction in the third embodiment.

FIG. 6 is a flowchart showing the procedure of the correction value calculation process in the third embodiment.

FIGS. 7A and 7B are graphs showing the 2-phase sinusoidal signals in the third embodiment, whose offset, amplitude ratio, and phase difference have been corrected.

FIGS. 8A and 8B are graphs showing the 2-phase sinusoidal signal in the third embodiment, whose 2nd and 5th harmonics have been further corrected.

### DETAILED DESCRIPTION OF THE EMBODIMENTS

### First Embodiment

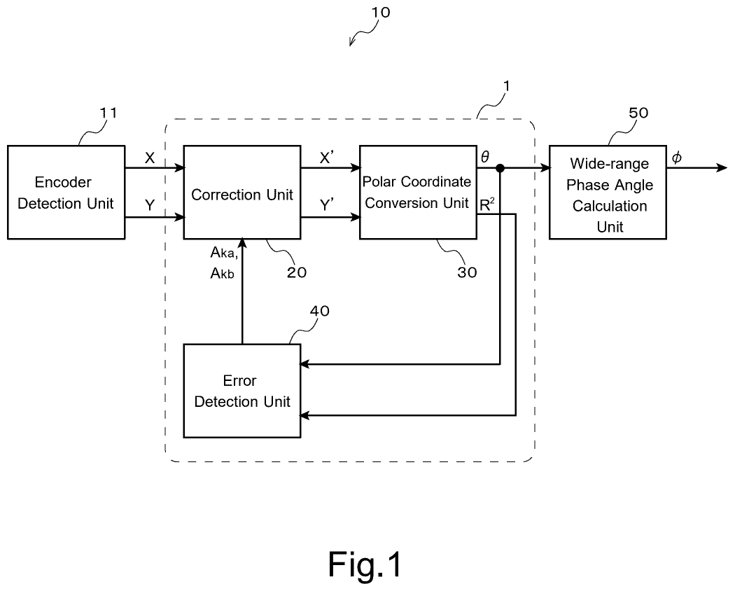

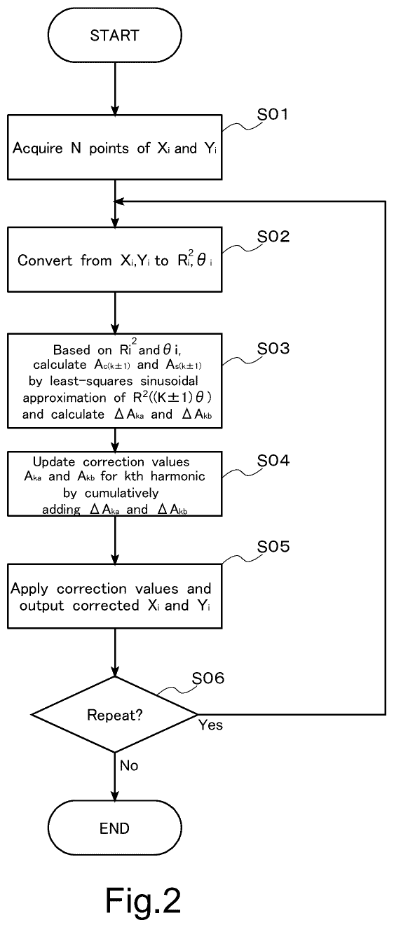

In the following, the first embodiment will be described on the basis of FIGS. 1 and 2.

A correction value calculation apparatus 1 calculates correction values to correct 2-phase sinusoidal signals at an encoder 10. FIG. 1 is a block diagram showing the basic configuration of the correction value calculation apparatus 1 of the first embodiment together with an encoder detection unit 11 and a wide-range phase angle calculation unit 50 in the encoder 10.

As shown in FIG. 1, the correction value calculation apparatus 1 is implemented in the form of being built into the encoder 10 together with the encoder detection unit 11 and the wide-range phase angle calculation unit 50. In the present embodiment, encoder 10 includes the encoder detection unit 11 that outputs a 2-phase sinusoidal signals corresponding to displacement along the measurement direction, the correction value calculation apparatus 1, and the wide-range phase angle calculation unit 50 that calculates the wide-range phase angle φ (e.g., corresponding to the rotational displacement of a rotary encoder), which is the final output of the encoder 10, from the phase angle θ calculated by the correction value calculation apparatus 1. The correction value calculation apparatus 1 includes a correction unit 20, an error detection unit 40, and a polar coordinate conversion unit 30. The correction value calculation apparatus 1 performs a correction value calculation process that calculates correction values based on the 2-phase sinusoidal signals output by the encoder detection unit 11, and a correction process that applies the correction values calculated in advance to the 2-phase sinusoidal signals output by the encoder detection unit 11. In such an implementation form built into the encoder 10, the correction value calculation apparatus 1 can dynamically update the correction values while detecting displacement, if the correction values can be calculated quickly enough.

As another implementation form of the correction value calculation apparatus 1, the correction value calculation apparatus 1 may be implemented as a separate unit from the encoder 10. For example, the correction value calculation apparatus 1 can be realized by a computer that is separate from the encoder detection unit 11. When the encoder detection unit 11 is installed at the location where displacement is measured, the correction value calculation apparatus 1 may acquire the data of the 2-phase sinusoidal signals acquired by the encoder detection unit 11 in the installed state via communication means or a storage medium, and calculate the correction values based on the acquired data. The calculated correction values may then be provided to the encoder detection unit 11 via the communication means or the storage medium.

The encoder detection unit 11 can use any detection principle, but may be, for example, a photoelectric type, a magnetic type, an electromagnetic induction type, or the like. Using the 2-phase sinusoidal signals output by the encoder detection unit 11, a Lissajous waveform (for example, with X as the horizontal axis and Y as the vertical axis) can be drawn. Ideally, the Lissajous waveform should have a constant Lissajous radius R regardless of the phase angle θ. However, the 2-phase sinusoidal signals output from the encoder detection unit 11 usually contain errors such as amplitude errors, phase difference errors, and offsets, so the Lissajous radius R is not constant regardless of the phase angle θ.

The analog 2-phase sinusoidal signal output by the encoder detection unit 11 is sampled and digitized at a predetermined frequency by AD converters not shown. In this specification, this group of digitized data of the 2-phase sinusoidal signals is referred to simply as “2-phase sinusoidal signals X and Y”. The digitized 2-phase sinusoidal signals X and Y are represented using a common index, such as “2-phase sinusoidal signals Xi and Yi,” to explicitly indicate the individual data sampled simultaneously, if necessary. In this specification, for the purpose of calculating the correction values, it is assumed that N pairs of digital data of the 2-phase sinusoidal signals X and Y are used. That is, in the data of 2-phase sinusoidal signals Xᵢ and Yᵢ used to calculate the correction values, i is an integer in the range 1 to N. Other parameters calculated from the “2-phase sinusoidal signals Xᵢ and Yᵢ” are also expressed using an index as necessary, such as the squared radius Rᵢ² and phase angle θᵢ.

The 2-phase sinusoidal signals X and Y are input to the correction unit 20. The correction unit 20 holds the correction values to be applied to the 2-phase sinusoidal signals. The correction values are calculated by the error detection unit 40. The correction unit 20 corrects the correction values using the 2-phase sinusoidal signals X and Y and outputs the output signals X′ and Y′. The output signals X′ and Y′ of the correction unit 20 are input to the polar coordinate conversion unit 30.

To explain the correction method in correction unit 20, the “least squares sinusoidal approximation” method is described, which uses N sets of (R², (k±1)θ) to accurately determine the amplitude of the kth harmonic contained in the 2-phase sinusoidal signals using the least squares method. First, the relationship between the squared radius R² and the Lissajous angle θ is derived for the 2-phase sinusoidal signals containing kth harmonics.

The ideal 2-phase sinusoidal signals x₁ and y₁ and 2-phase sinusoidal signals X and Y containing high-order harmonics xₖ and yₖ, can be expressed by Equations (1) and (2). When the radius R of the ideal 2-phase sinusoidal signals is assumed to be 1, x₁ and y₁ are expressed by Equations (3) and (4), respectively.

$$X = {x}_{1} + {{\sum }_{k = 2}}^{∞} {x}_{k} \qquad ( 1 )$$

$$Y = {y}_{1} + {{\sum }_{k = 2}}^{∞} {y}_{k} \qquad ( 2 )$$

$${x}_{1} = R cos θ = cos θ \qquad ( 3 )$$

$${y}_{1} = R sin θ = sin θ \qquad ( 4 )$$

$$where R = 1$$

Here, the amplitude of the kth harmonic is expressed as aₖ, the phase difference with the first harmonic (fundamental wave) is expressed as pₖ, and the phase difference between X and Y is assumed to be −π/2 radian (−90°) or +π/2 radian (+90°). That is, the harmonic amplitude and phase difference between the first and higher harmonics in X are equal to those in Y. Furthermore, if the phase difference between X and Y at the first order is +π/2 radian (+90°), the phase difference at the higher order is assumed to be −π/2 radian (−90°), and if the phase difference between X and Y at the first order is −π/2 radian (−90°), the phase difference at the higher order is assumed to be +π/2 radian (+90°). By introducing these assumptions, the four parameters of the high-order harmonics can be reduced to two.

Under the above assumptions, if the 2-phase sinusoidal signals X and Y contain only harmonics of kth order, then X is as in Equations (5) and (6), and Y is as in Equations (7) and (8).

$$X = {x}_{1} + {x}_{k} \qquad ( 5 )$$

$$\begin{matrix}{x}_{k} = {a}_{k} cos k ( θ + {p}_{k} ) \\ = {a}_{k} cos ( k θ + {kp}_{k} ) \\ = {a}_{k} cos {kp}_{k} cos k θ - {a}_{k} sin {kp}_{k} sin k θ\end{matrix} \qquad ( 6 )$$

$$Y = {y}_{1} + {y}_{k} \qquad ( 7 )$$

$$\begin{matrix}{y}_{k} = ∓ {a}_{k} sin k ( θ + {p}_{k} ) \\ = ∓ {a}_{k} sin ( k θ + {kp}_{k} ) \\ = ∓ {a}_{k} sin {kp}_{k} cos k θ ∓ {a}_{k} cos {kp}_{k} sin k θ\end{matrix} \qquad ( 8 )$$

From these equations, the squared radius R² can be obtained as shown in Equation (9).

$$\begin{matrix}{R}^{2} = {X}^{2} + {Y}^{2} \\ = 1 + {a}_{k}^{2} + 2 {a}_{k} cos {kp}_{k} ( cos ( k \pm 1 ) θ ) - 2 {a}_{k} sin {kp}_{k} ( sin ( k \pm 1 ) θ )\end{matrix} \qquad ( 9 )$$

That is, the squared radius R² of the 2-phase sinusoidal signals containing kth harmonics can be expressed as the sum of the cosine (cos) and sine (sin) of (k+1)θ or (k−1)θ. The amplitude of the cosine is 2aₖ cos kpₖ, and the amplitude of the sine is −2aₖ sin kpₖ.

For example, when the order of the high-order harmonic is k=2 and the polarity is −90°, in the above Equation (9), by setting k=2 and selecting the positive sign in the upper term, the squared radius R² can be expressed using cos 3θ and sin 3θ, and the correction calculation can be performed using this equation.

When Aₖₐ and A_{kb} are defined as in Equation (10), xₖ (Equation (6)) and yₖ (Equation (7)) can be expressed as the sum of the cosine (coskθ) term, the sine (sinkθ) term, and a constant term, as shown in Equations (11) and (12). When performing numerical calculations, it is easier to use the expressions in Equations (11) and (12) than the expressions in the second line of Equation (6), which use amplitude and phase. Therefore, the expressions using the sum of cosine and sine will be used hereafter.

$${A}_{ka} ≡ {a}_{k} cos {kp}_{k} \qquad ( 10 )$$

$${A}_{kb} ≡ {a}_{k} sin {kp}_{k}$$

$${x}_{k} = + {A}_{ka} cos k θ - {A}_{kb} sin k θ \qquad ( 11 )$$

$${y}_{k} = \pm {A}_{kb} cos k θ ∓ {A}_{ka} sin k θ \qquad ( 12 )$$

Next, by substituting Aₖₐ and A_{kb} (Equation (10)) into the squared radius R² (Equation (9)) of the 2-phase sinusoidal signals containing kth harmonics, the relationship between the squared radius R² and the Lissajous angle θ for the 2-phase sinusoidal signal containing kth harmonics is derived as Equation (13).

$${R}^{2} = 1 + {a}_{k}^{2} + 2 {A}_{ka} ( cos ( k \pm 1 ) θ ) - 2 {A}_{kb} ( sin ( k \pm 1 ) θ ) \qquad ( 13 )$$

Then, the cosine amplitude +2Aₖₐ and sine amplitude −2A_{kb} of the k±1th harmonics in Equation (13) are determined by the least squares method using N sets of (R², (k±1)θ). The specific calculation method is as follows.

First, assume that N pairs of data of 2-phase sinusoidal signals are given as Xᵢ and Yᵢ (i is an integer from 1 to N), and Rᵢ² and θᵢ are obtained. Since Rᵢ² is the sum of the squares of Xᵢ and Yᵢ, it can be easily calculated using Equation (14). (k±1)θᵢ can be calculated using Equation (15).

$${R}_{i}^{2} = {X}_{i}^{2} + {Y}_{i}^{2} \qquad ( 14 )$$

$$( k \pm 1 ) {θ}_{i} = ( k \pm 1 ) \cdot {tan}^{- 1} \frac{{Y}_{i}}{{X}_{i}} \qquad ( 15 )$$

On the other hand, by creating a system of three simultaneous linear equations for Rᵢ² and (k±1)θᵢ using Equation (16) as an approximate expression model for the squared radius R² of the 2-phase sinusoidal signals containing kth harmonic components, and multiplying the inverse matrix A_{(k±1)}⁻¹ of the matrix A_{(k±1)} by the matrix B_{(k±1)}, three variables A_{c(k±1)}, A_{s(k±1)}, and R_{o(k±1)}, which are the coefficients in the above approximate expression model, can be determined as elements of the C_{(k±1)} matrix.

$${R}^{2} = {R}_{o ( k \pm 1 )} + {A}_{c ( k \pm 1 )} cos ( k \pm 1 ) θ + {A}_{s ( k \pm 1 )} sin ( k \pm 1 ) θ \qquad ( 16 )$$

$${A}_{( k \pm 1 )} = [ \begin{matrix}\sum {cos}^{2} ( k \pm 1 ) {θ}_{i} & \sum sin ( k \pm 1 ) {θ}_{i} cos ( k \pm 1 ) {θ}_{i} & \sum cos ( k \pm 1 ) {θ}_{i} \\ \sum cos ( k \pm 1 ) {θ}_{i} sin ( k \pm 1 ) {θ}_{i} & \sum {sin}^{2} ( k \pm 1 ) {θ}_{i} & \sum sin ( k \pm 1 ) {θ}_{i} \\ \sum cos ( k \pm 1 ) {θ}_{i} & \sum sin ( k \pm 1 ) {θ}_{i} & N\end{matrix} ] \qquad ( 17 )$$

$${B}_{( k \pm 1 )} = [ \begin{matrix}\sum {R}_{i}^{2} cos ( k \pm 1 ) {θ}_{i} \\ \sum {R}_{i}^{2} sin ( k \pm 1 ) {θ}_{i} \\ \sum {R}_{i}^{2}\end{matrix} ]$$

$${C}_{( k \pm 1 )} = [ \begin{matrix}{A}_{c ( k \pm 1 )} \\ {A}_{s ( k \pm 1 )} \\ {A}_{o ( k \pm 1 )}\end{matrix} ]$$

$${A}_{( k \pm 1 )} \cdot {C}_{1 ( k \pm 1 )} = {B}_{( k \pm 1 )}$$

$${C}_{( k \pm 1 )} = {A}_{( k \pm 1 )}^{- 1} \cdot {B}_{( k \pm 1 )}$$

Furthermore, by substituting A_{c(k±1)} and A_{s(k±1)} into Equation (18), the correction values Aₖₐ and A_{kb} can be obtained.

$${A}_{ka} = \frac{{A}_{c ( k \pm 1 )}}{2} \qquad ( 18 )$$

$${A}_{kb} = - \frac{{A}_{s ( k \pm 1 )}}{2}$$

In this way, by calculating the amplitude A_{c(k±1)} of cos (k±1)θ and the amplitude A_{s(k±1)} of sin (k±1)θ in model Equation (16) using the least squares method, the cosine amplitude Aₖₐ and the sine amplitude A_{kb} can be obtained. Furthermore, by using Equations (19) and (20), the kth harmonic components xₖᵢ and yₖᵢ of the data of the 2-phase sinusoidal signals Xᵢ and Yᵢ can be obtained. By subtracting these harmonic components from the data of the 2-phase sinusoidal signals Xᵢ and Yᵢ, respectively, the ideal sinusoidal signals x₁ and y₁, which have the kth harmonic components removed, can be obtained.

$${x}_{ki} = {A}_{ka} cos k {θ}_{i} - {A}_{kb} sin k {θ}_{i} \qquad ( 19 )$$

$${y}_{ki} = ∓ {A}_{kb} cos k {θ}_{i} ∓ {A}_{ka} sin k {θ}_{i} \qquad ( 20 )$$

θᵢ contained in the kth harmonic components xₖᵢ and yₖᵢ obtained in this manner is preferably determined from x₁ and y₁, which do not contain high-order harmonics. However, as an alternative, the method of determining θᵢ from 2-phase sinusoidal signal data Xᵢ and Yᵢ containing the high-order harmonics is described. Therefore, this method introduces errors in xₖᵢ and yₖᵢ. These errors can be reduced by using a cumulative operation method. Next, the cumulative operation method for kth harmonic correction is explained.

For the correction values Aₖₐ and A_{kb} for the kth harmonic components obtained from the least squares sinusoidal approximation described above, Aₖₐ is replaced with the correction residual ΔAₖₐ, and A_{kb} is replaced with the correction residual ΔA_{kb} as shown in Equation (21), and the corrected values Aₖₐ and A_{kb} are obtained by cumulatively adding them as shown in Equation (22). Here, in Equation (22), the feedback gain G_{f} (where 0<G_{f}≤1) is multiplied by the correction residuals ΔAₖₐ and ΔA_{kb} to update each correction value. When updating the correction values, setting the feedback gain G_{f} to G_{f}<1 prevents the influence of the correction residuals from being excessively reflected in the correction values, thereby facilitating convergence of the correction residuals to values with small errors.

$$Δ {A}_{ka} = \frac{{A}_{c ( k \pm 1 )}}{2} \qquad ( 21 )$$

$$Δ {A}_{kb} = \frac{{A}_{s ( k \pm 1 )}}{2}$$

$${A}_{ka} = {A}_{ka} + {G}_{f} \cdot Δ {A}_{ka} \qquad ( 22 )$$

$${A}_{kb} = {A}_{kb} + {G}_{f} \cdot Δ {A}_{kb}$$

$$where 0 < {G}_{f} \leq 1.$$

Then, using Equations (19) and (20), the kth harmonic xₖᵢ and yₖᵢ are obtained from the correction values Aₖₐ and A_{kb}.

Furthermore, as shown in Equation (23), with m as the number of cumulative operations, the kth harmonic components xₖᵢ and yₖᵢ are subtracted from Xᵢ (m) and Yᵢ (m), which are the mth signals in the cumulative addition feedback loop, and the (m+1)th signals Xᵢ (m+1) and Yᵢ (m+1) are obtained. By repeating this process the desired number of times, the approximation errors of correction values Aₖₐ and A_{kb} can be reduced. With this correction method, it is possible to obtain correction values for cases where the 2-phase sinusoidal signals have no offset error, amplitude ratio error, or phase difference error, and only contains kth harmonic error, and to correct the kth harmonic error.

$${X}_{i} ( m + 1 ) = {X}_{i} ( m ) - {x}_{ki} \qquad ( 23 )$$

$${Y}_{i} ( m + 1 ) = {Y}_{i} ( m ) - {y}_{ki}$$

Next, a correction value calculation process that calculates correction values using the correction value calculation apparatus 1 will be described. FIG. 2 is a flowchart showing the procedure of the correction value calculation process in the first embodiment. The correction value calculation process is performed by the correction unit 20, the polar coordinate conversion unit 30, and the error detection unit 40. In the correction value calculation process, the correction values Aₖₐ and A_{kb} of the kth harmonics are obtained from the 2-phase sinusoidal signals X and Y.

When the correction value calculation process is started, the correction unit 20 first acquires N pairs of digital data of the 2-phase sinusoidal signals X and Y (Xᵢ, Yᵢ; where i is 1 to N) as output data of the encoder detection unit 11 for correction (step S01). The correction unit 20 may acquire this data in real time from the encoder detection unit 11, or the encoder detection unit 11 may acquire and record the data in advance, which is then acquired by the correction unit 20 via communication means or a storage medium. Then, the polar coordinate conversion unit 30 calculates the phase angle θᵢ and the corresponding squared radius Rᵢ² for each of the N data pairs of the 2-phase sinusoidal signals (step S02; polar coordinate calculation step).

Then, based on each phase angle θᵢ and squared radius Rᵢ² calculated in step S02, the error detection unit 40 calculates the amplitudes A_{c(k±1)} and A_{s(k±1)} using the least squares sinusoidal approximation, and calculates the correction residuals ΔAₖₐ and ΔA_{kb} (step S03; least squares sinusoidal approximation step).

Then, the calculated correction residuals ΔAₖₐ and ΔA_{kb} are cumulatively added to the correction values using Equation (20), and the correction values Aₖₐ and A_{kb} for the kth harmonic are updated (step S04; harmonics correction value calculation step).

Next, the correction unit 20 corrects the 2-phase sinusoidal signals based on the correction values Aₖₐ and A_{kb} calculated by the error detection unit 40, and outputs the corrected data of the 2-phase sinusoidal signal Xi and Yi (step S05; correction step).

If the calculation of correction values is repeated (step S06; Yes), processing returns to step S02. Steps S02 through S05 are repeated as many times as necessary, and when repetition is no longer required (step S06; No), the correction value calculation process ends. The correction values at the end of the correction value calculation process are the final correction values. The number of times the correction values are repeatedly calculated and updated may be a predetermined number. Alternatively, the process may be repeated until the correction residuals are sufficiently small (e.g., until they fall below a predetermined threshold).

According to the correction value calculation apparatus 1 and the correction value calculation process of the first embodiment described above, it is possible to perform arbitrary kth harmonic correction, and even if the data has unequal pitches, they can be corrected without using a master encoder. Therefore, it is possible to perform high-precision correction with a small number of data points without requiring a high-precision feed mechanism or high-precision control. Furthermore, when increasing the number of data points to achieve higher precision, the calculation of the squared radius R² can be easily performed since it is the sum of the squares of the 2-phase sinusoidal signals. Therefore, it is possible to efficiently and accurately calculate higher-order harmonics of the interpolation error in 2-phase sinusoidal signals using a simple method, thereby reducing computational resources and achieving high-speed calculations.

### Second Embodiment

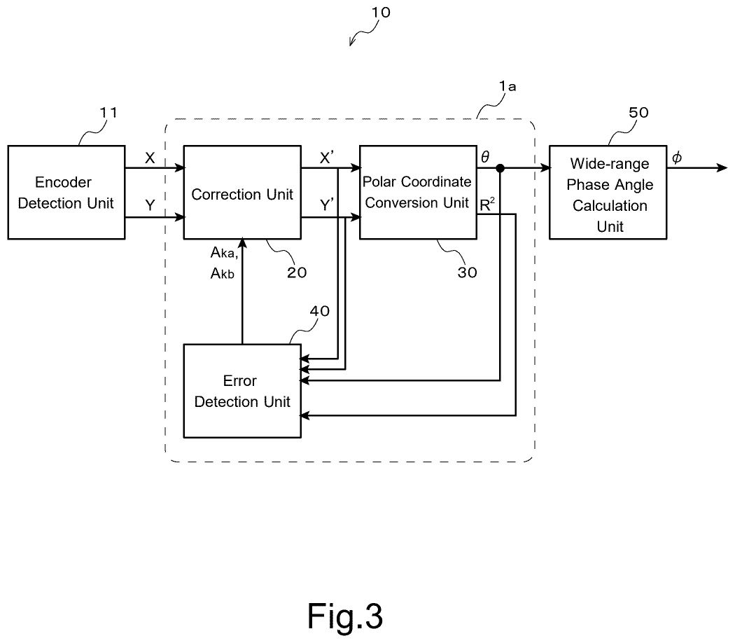

The second embodiment of the present invention will now be described below. This second embodiment performs the correction value calculation process at a higher speed with fewer operations than the first embodiment. FIG. 3 is a block diagram showing an correction value calculation apparatus 1a according to the second embodiment. As shown in FIG. 3, the configuration of the correction value calculation apparatus 1a is generally similar to that of the first embodiment, but differs from the first embodiment in that the error detection unit 40a calculates the correction value by additionally using the 2-phase sinusoidal signals X′ and Y′. However, since the other configurations are the same, the following description mainly explains the operations in the correction value calculation process of the second embodiment.

In the first embodiment described above, trigonometric calculations are required to obtain correction values Aₖₐ and A_{kb}. In contrast, in the second embodiment, the calculations can be simplified by replacing the trigonometric functions with polynomials of 2-phase sinusoidal signals X and Y. In the following, the calculation method is explained using an example where the harmonic to be removed is a 2nd harmonic (k=2, polarity −90°). First, the 2-phase sinusoidal signal X containing the 2nd harmonic component is expressed by Equation (24), and the 2nd harmonic component x₂ is expressed by Equation (25). Similarly, the 2-phase sinusoidal signal Y containing the 2nd harmonic component is expressed by Equation (26), and the 2nd harmonic component y₂ is expressed by Equation (27).

$$X = {x}_{1} + {x}_{2} \qquad ( 24 )$$

$${x}_{2} = {a}_{2} cos 2 ( θ + {p}_{2} ) \qquad ( 25 )$$

$$Y = {y}_{1} + {y}_{2} \qquad ( 26 )$$

$${y}_{2} = - {a}_{2} sin 2 ( θ + {p}_{2} ) \qquad ( 27 )$$

Next, data of the 2-phase sinusoidal signal X′ᵢ and Y′ᵢ, in which the N pairs of data of the 2-phase sinusoidal signals Xᵢ and Yᵢ with i=1, 2, . . . , N are normalized to 1 neighborhood (in other words, ΣRᵢ²/N≈1), are obtained. The normalization method is arbitrary, but for example, it is desirable to normalize using a method such as the following: first, determine in advance an amplitude normalization coefficient Kₓ such that R=1 when the relative position between the encoder scale and the read head is the designed reference position, and then apply the amplitude normalization coefficient Kₓ to the data Xᵢ and Yᵢ using Equations (28) and (29) to obtain the data X′ᵢ and Y′ᵢ. Alternatively, if the average of the squared radius Rᵢ² can be considered to be 1, the 2-phase sinusoidal data Xᵢ and Yᵢ can be used as X′ᵢ and Y′ᵢ without normalization.

$${X}_{i}^{′} = {K}_{x} * {X}_{i} \qquad ( 28 )$$

$${Y}_{i}^{′} = {K}_{x} * {Y}_{i} \qquad ( 29 )$$

Then, for the normalized 2-phase sinusoidal signals X′ᵢ and Y′ᵢ, Rᵢ² and θᵢ are obtained using Equations (30) and (31), respectively.

$${R}_{i}^{2} = {X}_{i}^{′ 2} + {Y}_{i}^{′ 2} \qquad ( 30 )$$

$${θ}_{i} = {tan}^{- 1} \frac{{Y}_{i}^{′}}{{X}_{i}^{′}} \qquad ( 31 )$$

Then, in order to apply the least squares sinusoidal approximation with Equation (32) as the model equation to the data (Rᵢ², 3θᵢ), i=1, 2, . . . , N, solve the simultaneous equations shown in the matrix operation of Equation (33) to obtain matrix C₃, and thereby obtain A_{c3} and Aₛ₃. At this stage, as shown in Equations (34) and (35), the triple-angle formulas for trigonometric functions are applied, and furthermore, cos θᵢ and sin θᵢ are approximated by X′ᵢ and Y′ᵢ, respectively, thereby replacing the trigonometric functions contained in each element of the matrix with polynomials of X′ᵢ and Y′ᵢ. In this way, the calculations can be simplified. As shown in Equations (34) and (35), the approximation of cos 3θᵢ shall be abbreviated as CS3ᵢ and the approximation of sin 3θᵢ as SN3ᵢ.

$${R}^{2} = {R}_{o 3} + {A}_{c 3} cos 3 θ + {A}_{s 3} sin 3 θ \qquad ( 32 )$$

$$\begin{matrix}{A}_{3} = [ \begin{matrix}\sum {cos}^{2} 3 {θ}_{i} & \sum sin 3 {θ}_{i} cos 3 {θ}_{i} & \sum cos 3 {θ}_{i} \\ \sum sin 3 {θ}_{i} cos 3 {θ}_{i} & \sum {sin}^{2} 3 {θ}_{i} & \sum sin 3 {θ}_{i} \\ \sum cos 3 {θ}_{i} & \sum sin 3 {θ}_{i} & N\end{matrix} ] \\ = [ \begin{matrix}\sum {( CS {3}_{i} )}^{2} & \sum ( CS {3}_{i} ) ( SN {3}_{i} ) & \sum ( CS {3}_{i} ) \\ \sum ( CS {3}_{i} ) ( SN {3}_{i} ) & \sum {( SN {3}_{i} )}^{2} & \sum ( SN {3}_{i} ) \\ \sum ( CS {3}_{i} ) & \sum ( SN {3}_{i} ) & N\end{matrix} ]\end{matrix} \qquad ( 33 )$$

$$\begin{matrix}{B}_{3} = [ \begin{matrix}\sum {R}_{i}^{2} cos 3 {θ}_{i} \\ \sum {R}_{i}^{2} sin 3 {θ}_{i} \\ \sum {R}_{i}^{2}\end{matrix} ] \\ = [ \begin{matrix}\sum {R}_{i}^{2} ( CS {3}_{i} ) \\ \sum {R}_{i}^{2} ( SN {3}_{i} ) \\ \sum {R}_{i}^{2}\end{matrix} ]\end{matrix}$$

$${C}_{3} = [ \begin{matrix}{A}_{c 3} \\ {A}_{s 3} \\ {A}_{o 3}\end{matrix} ]$$

$${A}_{3} \cdot {C}_{3} = {B}_{3}$$

$${C}_{3} = {A}_{3}^{- 1} \cdot {B}_{3}$$

$$\begin{matrix}cos 3 {θ}_{i} = {( 4 sin {θ}_{i} )}^{3} - 3 sin {θ}_{i} \\ \approx 4 {X}_{i}^{′ 3} - 3 {X}_{i}^{′} \\ ≡ CS {3}_{i}\end{matrix} \qquad ( 34 )$$

$$\begin{matrix}sin 3 {θ}_{i} = 3 sin {θ}_{i} - {( 4 sin {θ}_{i} )}^{3} \\ \approx 3 {Y}_{i}^{′} - 4 {Y}_{i}^{′ 3} \\ ≡ SN {3}_{i}\end{matrix} \qquad ( 35 )$$

Thereafter, similarly to the case where k=2 in Equations (19) to (23) in the first embodiment, Xᵢ′ (m+1) and Yᵢ′ (m+1) can be obtained through m times cumulative operations of 2nd harmonic correction by Equations (36) to (42). In other words, the correction residuals ΔA₂ₐ and ΔA_{2b} are obtained using Equation (36), and the correction values A₂ₐ and A_{2b} are updated using the correction residuals ΔA₂ₐ and ΔA_{2b} in Equation (37).

$$Δ {A}_{2 a} = \frac{{A}_{c 3}}{2} \qquad ( 36 )$$

$$Δ {A}_{2 b} = \frac{{A}_{s 3}}{2}$$

$${A}_{2 a} = {A}_{2 a} + {G}_{f} \cdot Δ {A}_{2 a} \qquad ( 37 )$$

$${A}_{2 b} = {A}_{2 b} + {G}_{f} \cdot Δ {A}_{2 b}$$

$$where 0 < {G}_{f} \leq 1.$$

Then, using the correction values A₂ₐ and A_{2b}, the 2nd harmonics x₂₁ and y₂₁ are obtained using Equations (38) and (39). In the calculation of x₂₁ and y₂₁, as shown in Equations (40) and (41), it is possible to simplify the calculation by using the double angle formula for trigonometric functions and approximating the terms cos 2θᵢ and sin 2θᵢ with polynomials of Xᵢ′ and Yᵢ′. As shown in Equations (40) and (41), the approximation of cos2θᵢ shall be abbreviated as CS2ᵢ and the approximation of sin 2θᵢ as SN2ᵢ.

$$\begin{matrix}{x}_{2 i} = {A}_{2 a} cos 2 {θ}_{i} - {A}_{2 b} sin 2 {θ}_{i} \\ = {A}_{2 a} CS {2}_{i} - {A}_{2 b} SN {2}_{i}\end{matrix} \qquad ( 38 )$$

$$\begin{matrix}{y}_{2 i} = - {A}_{2 b} cos 2 {θ}_{i} - {A}_{2 a} sin 2 {θ}_{i} \\ = - {A}_{2 b} CS {2}_{i} - {A}_{2 a} SN {2}_{i}\end{matrix} \qquad ( 39 )$$

$$\begin{matrix}cos 2 {θ}_{i} = {( 2 sin {θ}_{i} )}^{2} - 1 \\ \approx 2 {X}_{i}^{′ 2} - 1 \\ ≡ CS {2}_{i}\end{matrix} \qquad ( 40 )$$

$$\begin{matrix}sin 2 {θ}_{i} = 2 cos {θ}_{i} sin {θ}_{i} ) \\ \approx 2 {X}_{i}^{′} {Y}_{i}^{′} \\ ≡ SN {2}_{i}\end{matrix} \qquad ( 41 )$$

Furthermore, as shown in Equation (42), the 2nd harmonics x₂₁ and y₂₁ are subtracted from Xᵢ (m) and Yᵢ (m), which are the mth signals in the cumulative addition feedback loop, and the m+1th signals Xᵢ (m+1) and Yᵢ (m+1) are obtained. By repeating this process the desired number of times, the approximation errors of correction values A₂ₐ and A_{2b} can be reduced.

$${X}_{i}^{′} ( m + 1 ) = {X}_{i}^{′} ( m ) - {x}_{2 i} \qquad ( 42 )$$

$${Y}_{i}^{′} ( m + 1 ) = {Y}_{i}^{′} ( m ) - {y}_{2 i}$$

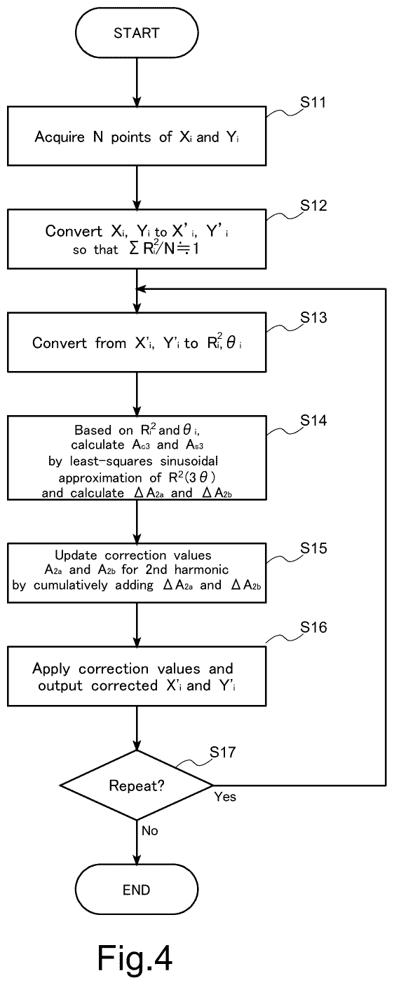

Next, a correction value calculation process that calculates correction values using the correction value calculation apparatus 1a will be described. FIG. 4 is a flowchart showing the procedure of the correction value calculation process in the second embodiment. The correction value calculation process is performed by the correction unit 20, the polar coordinate conversion unit 30, and the error detection unit 40a.

When the correction value calculation process is started, the correction unit 20 first acquires N pairs of digital data of 2-phase sinusoidal signals X and Y (Xᵢ, Yᵢ; where i is 1 to N) as output data of the encoder detection unit 11 for correction (step S11). The correction unit 20 may acquire this data in real time from the encoder detection unit 11, or the encoder detection unit 11 may acquire and record the data in advance, which is then acquired by the correction unit 20 via communication means or a storage medium. Next, the correction unit 20 converts Xᵢ and Yᵢ to X′ᵢ and Y′ᵢ so that the relationship ΣRᵢ²/N≈1 is satisfied (step S12). Through this, the amplitude of the 2-phase sinusoidal signals is adjusted so that the condition R²=1 is satisfied. After the conversion by the correction unit 20, the polar coordinate conversion unit 30 calculates the phase angle θᵢ and the corresponding squared radius Rᵢ² for each of the N data pairs of the 2-phase sinusoidal signals from X′ᵢ and Y′ᵢ (step S13).

Then, based on 2-phase sinusoidal signals X′ᵢ and Y′ᵢ and squared radius Rᵢ², the error detection unit 40a calculates the cosine amplitude A_{c3} and the sine amplitude Aₛ₃ by the least squares sinusoidal approximation using Equations (33) to (35), and calculates the correction residuals ΔA₂ₐ and ΔA_{2b} by Equations (36) and (37) (step S14).

Then, the correction values A₂ₐ and A_{2b} are updated by cumulatively adding the calculated correction residuals ΔA₂ₐ and ΔA_{2b} (step S15).

Next, the correction unit 20 calculates x₂₁ and y₂₁ based on the correction values for the second harmonic A₂ₐ and A_{2b} calculated by the error detection unit 40a, and corrects the 2-phase sinusoidal signals X′ᵢ and Y′ᵢ by subtracting x2ᵢ and y2ᵢ from the 2-phase sinusoidal signals (step S16).

If the calculation of correction values is repeated (step S17; Yes), processing returns to step S13. Steps S13 through S16 are repeated as many times as necessary, and when repetition is no longer required (step S17; No), the correction value calculation process ends. The correction values at the end of the correction value calculation process are the final correction values. The number of times the correction values are repeatedly calculated and updated may be a predetermined number. Alternatively, the process may be repeated until the correction residuals are sufficiently small (e.g., until they fall below a predetermined threshold).

In the second embodiment described above, the trigonometric functions appearing in the calculation of the correction values for the 2nd harmonics were replaced with polynomials of Xᵢ and Yᵢ to simplify the calculation. However, the same simplification can be applied to the calculation when correcting harmonics other than the second harmonic. That is, when the order of the harmonic to be corrected is k, the trigonometric functions appear in Equations (17), (19), and (20) in the first embodiment (namely, cos (k+1)θᵢ, sin (k+1)θᵢ, coskθᵢ, and sinkθᵢ) can be expressed using the commonly known k-angle and k+1-angle formulas for trigonometric functions, replacing them with cos θᵢ and sin θᵢ, and further approximating cos θᵢ and sin θᵢ with Xᵢ and Yᵢ, respectively, thereby simplifying the calculations by replacing the trigonometric functions with the polynomials of Xᵢ′ and Yᵢ′. Unless there are other constraints such as computational resources or computation time, there is no upper limit on the order of k. If yₖ is of opposite polarity to xₖ (i.e., the phase shift is in the opposite direction), the fluctuation of R² will be (k−1)th order. At this time, for any integer k≥4, the correction can be made in the same way as in the case of positive polarity.

That is, Equation (17) can be simplified as Equations (43) to (45).

$$\begin{matrix}{A}_{( k \pm 1 )} = [ \begin{matrix}\sum {( {CS ( k \pm 1 )}_{i} )}^{2} & \sum ( {CS ( k \pm 1 )}_{i} ) ( {SN ( k \pm 1 )}_{i} ) & \sum ( {CS ( k \pm 1 )}_{i} ) \\ \sum ( {CS ( k \pm 1 )}_{i} ) ( {SN ( k \pm 1 )}_{i} ) & \sum {( {SN ( k \pm 1 )}_{i} )}^{2} & \sum ( {SN ( k \pm 1 )}_{i} ) \\ \sum ( {CS ( k \pm 1 )}_{i} ) & \sum ( {SN ( k \pm 1 )}_{i} ) & N\end{matrix} ] \\ {B}_{( k \pm 1 )} = [ \begin{matrix}\sum {R}_{i}^{2} ( {CS ( k \pm 1 )}_{i} ) \\ \sum {R}_{i}^{2} ( {SN ( k \pm 1 )}_{i} ) \\ \sum {R}_{i}^{2}\end{matrix} ] \\ {C}_{( k \pm 1 )} = [ \begin{matrix}{A}_{c ( k \pm 1 )} \\ {A}_{s ( k \pm 1 )} \\ {R}_{o ( k \pm 1 )}\end{matrix} ] \\ {A}_{( k \pm 1 )} \cdot {C}_{( k \pm 1 )} = {B}_{( k \pm 1 )} \\ {C}_{( k \pm 1 )} = {A}_{( k \pm 1 )}^{- 1} \cdot {B}_{( k \pm 1 )}\end{matrix} \qquad ( 43 )$$

$$\begin{matrix}cos ( k \pm 1 ) {θ}_{i} = {\sum }_{p = 0}^{[ ( k \pm 1 ) / 2 ]} \frac{{( - 1 )}^{p} ( k \pm 1 )}{2 ( k \pm 1 - p )} {}_{k \pm 1 - p} {C}_{p} {( 2 cos {θ}_{i} )}^{k \pm 1 - 2 p} \\ \approx {\sum }_{p = 0}^{[ ( k \pm 1 ) / 2 ]} \frac{{( - 1 )}^{p} ( k \pm 1 )}{2 ( k \pm 1 - p )} {}_{k \pm 1 - p} {C}_{p} {( 2 {X}_{i} )}^{k \pm 1 - 2 p} \\ ≡ {CS ( k \pm 1 )}_{i}\end{matrix} \qquad ( 44 )$$

$$\begin{matrix}sin ( k \pm 1 ) {θ}_{i} = sin θ {\sum }_{p = 0}^{[ ( k \pm 1 - 1 ) / 2 ]} {( - 1 )}^{p} {}_{k \pm 1 - p - 1} {C}_{p} {( 2 cos {θ}_{i} )}^{k \pm 1 - 2 p - 1} \\ \approx {Y}_{i} {\sum }_{p = 0}^{[ ( k \pm 1 - 1 ) / 2 ]} {( - 1 )}^{p} {}_{k \pm 1 - p - 1} {C}_{p} {( 2 {X}_{i} )}^{k \pm 1 - 2 p - 1} \\ ≡ {SN ( k \pm 1 )}_{i}\end{matrix} \qquad ( 45 )$$

Note that in Equations (44) and (45), [x] is a Gaussian symbol representing the largest integer not exceeding x.

Equations (19) and (20) can be simplified as Equations (46) to (49).

$${x}_{ki} = {A}_{ka} {CSk}_{i} - {A}_{kb} {SNk}_{i} \qquad ( 46 )$$

$${y}_{ki} = ∓ {A}_{kb} {CSk}_{i} ∓ {A}_{ka} {SNk}_{i} \qquad ( 47 )$$

$$\begin{matrix}cos k {θ}_{i} = {\sum }_{p = 0}^{[ k / 2 ]} \frac{{( - 1 )}^{p} k}{2 ( k - p )} {}_{k - p} {C}_{p} {( 2 cos {θ}_{i} )}^{k - 2 p} \\ \approx {\sum }_{p = 0}^{[ k / 2 ]} \frac{{( - 1 )}^{p} k}{2 ( k - p )} {}_{k - p} {C}_{p} {( 2 {X}_{i} )}^{k - 2 p} ≡ {CSk}_{i}\end{matrix} \qquad ( 48 )$$

$$\begin{matrix}sin k {θ}_{i} = sin θ {\sum }_{p = 0}^{[ ( k - 1 ) / 2 ]} {( - 1 )}^{p} {}_{k - p - 1} {C}_{p} {( 2 cos {θ}_{i} )}^{k - 2 p - 1} \\ \approx {Y}_{i} {\sum }_{p = 0}^{[ ( k - 1 ) / 2 ]} {( - 1 )}^{p} {}_{k - p - 1} {C}_{p} {( 2 {X}_{i} )}^{k - 2 p - 1} ≡ {SNk}_{i}\end{matrix} \qquad ( 49 )$$

Note that in Equations (48) and (49), [x] is a Gaussian symbol representing the largest integer not exceeding x.

Table 1 shows the polynomials of X′ and Y′ that can replace coskθ and sinkθ (k=1 to 6) together with their abbreviated notation.

TABLE 1

| Trigonometric | | Abbreviated |
|---|---|---|
| Function | Polynomial | Notation |
| cos θ | X′ | CS1 |
| sin θ | Y′ | SN1 |
| cos 2θ | 2X′² − 1 | CS2 |
| sin 2θ | 2X′Y′ | SN2 |
| cos 3θ | 4X′³ − 3X′ | CS3 |
| sin 3θ | 3Y′ − 4Y′³ | SN3 |
| cos 4θ | 8X′⁴ − 8X′² + 1 | CS4 |
| sin 4θ | 4X′Y′ − 8X′Y′³ | SN4 |
| cos 5θ | 16X′⁵ − 20X′³ + 5X′ | CS5 |
| sin 5θ | 16Y′⁵ − 20Y′³ + 5Y′ | SN5 |
| cos 6θ | 32X′⁶ − 48X′⁴ + 18X′² − 1 | CS6 |
| sin 6θ | 32X′Y′⁵ − 32X′Y′³ + 6X′Y′ | SN6 |

In this way, according to the present embodiment, the correction values can be obtained by simplified calculations that do not include trigonometric functions. Simplified calculations that do not include trigonometric functions enable shorter calculation times and reduced calculation resources, allowing implementation in low-cost, compact, and low-power embedded devices. Furthermore, as in the first embodiment, it is possible to efficiently and accurately calculate correction values for high-order harmonics of interpolation errors in 2-phase sinusoidal signals by a simple method.

### Third Embodiment

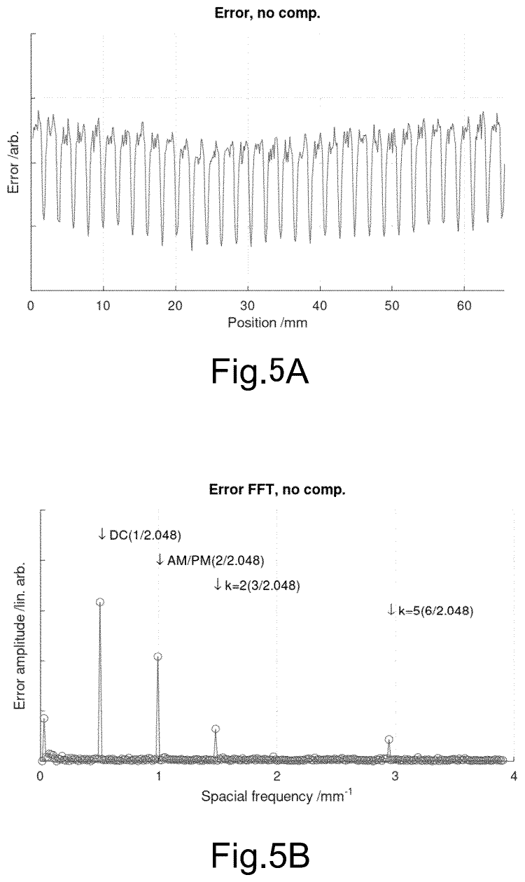

In the following, the third embodiment of the present invention will be described on the basis of FIGS. 5A to 8B.

In the first and second embodiments described above, for ease of explanation, only the high-order harmonics were corrected for 2-phase sinusoidal signals that did not include errors in offset, amplitude ratio, and phase difference. In this embodiment, a correction method for 2-phase sinusoidal signals that include errors in offset, amplitude ratio, and phase difference in addition to the high-order harmonics is described. Furthermore, in this embodiment, the effect of the correction is explained using actual measurement data obtained from an actual electromagnetic induction type encoder. Since the configuration of the correction value calculation apparatus 1a is the same as that of the second embodiment, the following describes mainly the operations in the correction value calculation process of the third embodiment.

FIGS. 5A and 5B are graphs showing the error contained in the 2-phase sinusoidal signals before correction in the third embodiment. FIG. 5A shows the position on the horizontal axis, and FIG. 5B shows a Fourier transform of the waveform in FIG. 5A with the horizontal axis representing the frequency (spatial frequency). As shown in FIG. 5B, the 2-phase sinusoidal signals used in the third embodiment include offset errors indicated as DC in the drawing, and amplitude ratio and phase difference errors indicated as AM/PM in the drawing. Additionally, the two-phase sinusoidal waveform signal contains a higher proportion of second-order (k+1=3) and fifth-order (k+1=6) harmonics compared to other harmonics. Thus, depending on the detection method and the environment in which the encoder is used, the 2-phase sinusoidal signals may contain certain harmonic components as errors. In this embodiment, correction is performed to remove the 2nd and 5th harmonics, which are contained in greater amounts than other harmonics. In addition to corrections for harmonics, corrections are also made for the offset error, amplitude ratio error, and phase difference error.

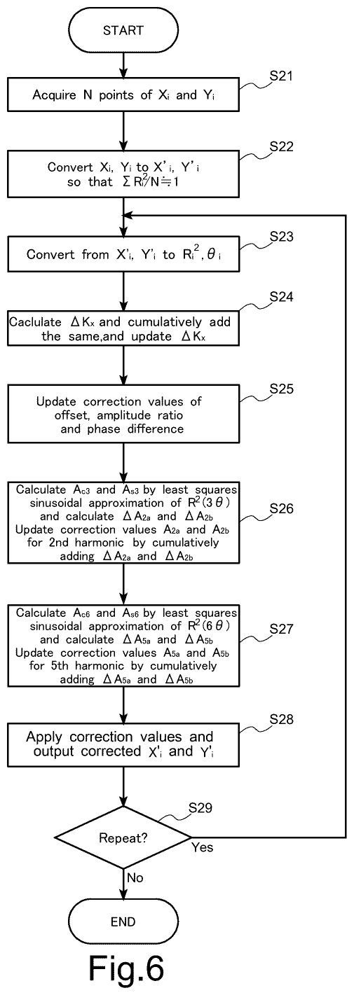

FIG. 6 is a flowchart showing the procedure of the correction value calculation process in the third embodiment. The correction value calculation process is performed by the correction unit 20, the polar coordinate conversion unit 30, and the error detection unit 40a.

When the correction value calculation process is started, the correction unit 20 first acquires N pairs of digital data of 2-phase sinusoidal signals X and Y (Xᵢ, Yᵢ; where i is 1 to N) as output data of the encoder detection unit 11 for correction (step S21). The correction unit 20 may acquire this data in real time from the encoder detection unit 11, or the encoder detection unit 11 may acquire and record the data in advance, which is then acquired by the correction unit 20 via communication means or a storage medium. Next, the correction unit 20 calculates and applies the amplitude normalization coefficient Kₓ according to Equations (28) and (29) so that the average of the squared radius Rᵢ² becomes 1 (i.e., ΣRᵢ²/N≈1), and converts Xᵢ and Yᵢ to X′ᵢ and Y′ᵢ (step S22). In this way, coarse adjustment of the amplitude of the 2-phase sinusoidal signals is performed to satisfy the condition R²=1. Subsequently, the polar coordinate conversion unit 30 calculates the phase angle θᵢ and the corresponding squared radius Rᵢ² for each of the N data pairs of the 2-phase sinusoidal signals based on X′ᵢ and Y′ᵢ (step S23).

Next, to satisfy the condition R²=1 with higher precision, the error (correction residual) ΔKₓ of the amplitude normalization coefficient Kₓ is calculated and cumulatively added to the existing amplitude normalization coefficient Kₓ (step S24).

Then, the correction values for the offset, amplitude ratio, and phase difference errors are obtained by arbitrary methods (step S25). For example, the error detection unit 40a may calculate the correction residuals for the offset, amplitude ratio, and phase difference errors using the method described in Japanese Patent Application No. 2023-109451, which was not published as of the filing date (priority date) of the present application, and update the correction values based on the correction residuals.

Then, in order to calculate the correction values for the 2nd harmonic, the error detection unit 40a calculates the cosine amplitude A_{c3} and the sine amplitude Aₛ₃ in the model equation expressing R² using trigonometric functions of 3θ by the least squares sinusoidal approximation, and calculates the correction residuals ΔA₂ₐ and ΔA_{2b}. And, the correction residuals ΔA₂ₐ and ΔA_{2b} are cumulatively added to obtain the correction values A₂ₐ and A_{2b} for the 2nd harmonics (step S26).

Then, in order to calculate the correction values for the 5th harmonics, the error detection unit 40a calculates the cosine amplitude Acs and the sine amplitude Aₛ₅ in the model equation expressing R² using trigonometric functions of 60 by the least squares sinusoidal approximation, and calculates the correction residuals ΔA₅ₐ and ΔA_{5b}. And, the correction residuals ΔA₅ₐ and ΔA_{5b} are cumulatively added to obtain the correction values A₅ₐ and A_{5b} for the 5th harmonics (step S26).

Next, the correction unit 20 applies the correction values obtained in each step to the 2-phase sinusoidal signals to perform correction (step S28). That is, the correction unit 20 corrects the amplitude normalization coefficient Kₓ based on the error ΔKₓ of the amplitude normalization coefficient obtained in step S23, and corrects the offset, amplitude ratio, and phase difference based on the correction values for the offset, amplitude ratio, and phase difference obtained in step S24. In addition, the correction unit 20 calculates the 2nd harmonics x₂ᵢ and y₂ᵢ based on the correction values A₂ₐ and A_{2b} for the second harmonic calculated in step S25, and performs 2nd harmonic correction by subtracting these from the 2-phase sinusoidal signals. In addition, the correction unit 20 calculates the second harmonic x₅ᵢ and y₅ᵢ based on the correction values A₅ₐ and A_{5b} for the 5th harmonics calculated in step S26, and performs 5th harmonic correction by subtracting these from the 2-phase sinusoidal signals. Then, the correction unit 20 outputs the 2-phase sinusoidal signals data X′ᵢ and Y′ᵢ with these corrections reflected.

If the calculation and update of correction values are repeated (step S29; Yes), processing returns to step S22. Steps S23 through S28 are repeated as many times as necessary, and when repetition is no longer required (step S29; No), the correction value calculation process ends. The correction values at the end of the correction value calculation process are the final correction values. The number of times the correction values are repeatedly calculated and updated may be a predetermined number. Alternatively, the process may be repeated until the correction residuals are sufficiently small (e.g., until they fall below a predetermined threshold).

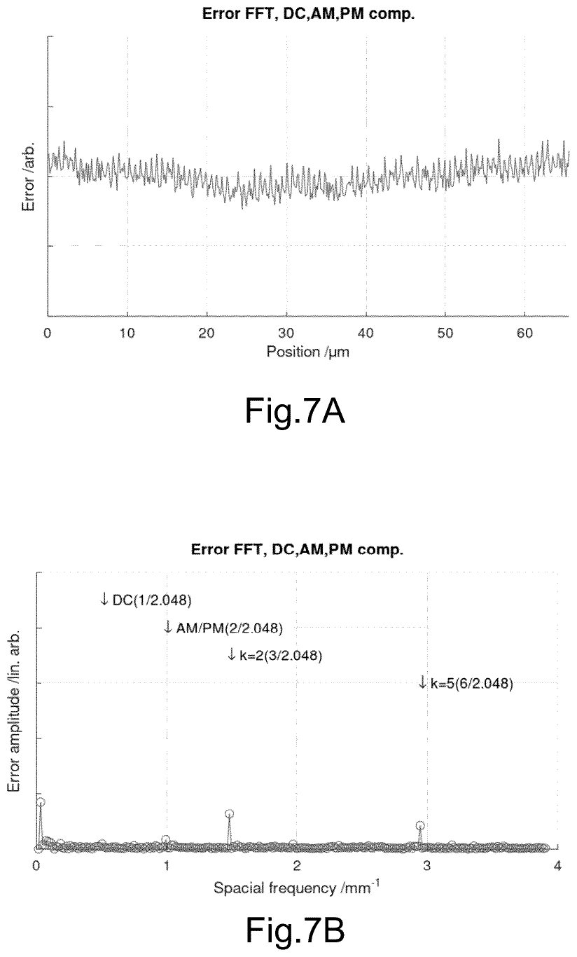

Hereinafter, the effects of the correction using the method of the present embodiment are described. The erroneous frequency components contained in the 2-phase sinusoidal signals before correction include offset error (indicated as DC in the drawing) and amplitude ratio and phase difference errors (indicated as AP/PM in the drawing), as well as 2nd and 5th harmonics, as shown in FIG. 5B. Meanwhile, when the offset, amplitude ratio, and phase difference correction values calculated in step S23 are applied to the 2-phase sinusoidal signals, the remaining errors become the waveform shown in FIG. 7A and the frequency spectrum shown in FIG. 7B, in which the error components of the offset, amplitude ratio, and phase difference are sufficiently reduced to be buried in the noise floor.

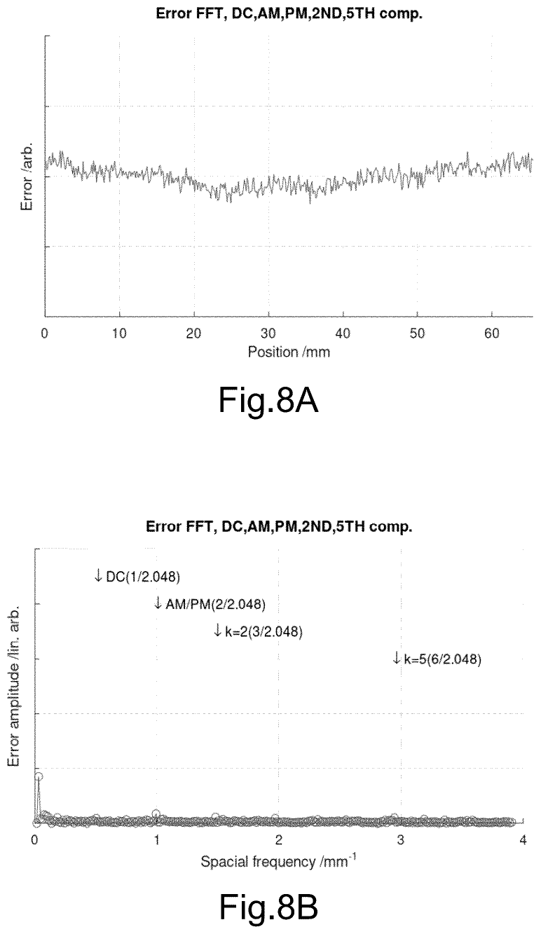

Furthermore, when the correction values for the 2nd harmonics calculated in step S24 and the correction values for the 5th harmonics calculated in step S25 are applied to the 2-phase sinusoidal signals, the remaining error becomes the waveform shown in FIG. 8A, and the frequency spectrum shown in FIG. 8B, in which the 2nd harmonic and 5th harmonic components are sufficiently reduced to be buried in the noise floor.

As can be seen from FIGS. 5A, 5B, 7A, 7B, 8A, and 8B, according to the method of the present embodiment, high-order harmonic correction of the 2nd harmonics and 5th harmonics is performed in addition to offset correction, amplitude ratio error correction, and phase difference error correction, thereby greatly reducing respective errors. Therefore, it can be seen that the correction method of the present invention effectively works in actual encoders.

In the third embodiment, in calculating the correction values for the high-order harmonic correction of the 2nd and 5th harmonics, the method described in the second embodiment in which the trigonometric functions are approximated by polynomials of X′ and Y′ to simplify the calculations was used. As can be seen from the above error reduction effect, even when the calculation is simplified using the method described in the second embodiment, it is possible to achieve sufficient correction accuracy.

### (Variation of Embodiments)

Although the embodiments are described above, the present invention is not limited to the examples. For example, the first to third embodiments described above are explained using an electromagnetic induction type encoder as an example, but they are not limited to electromagnetic induction type encoders, and may also be applied to interpolation correction for other detection types (optical, magnetic, etc.) of encoders possessing the 2-phase sinusoidal signals. In addition, the encoder to which the present invention is applied may be a rotary encoder, or the encoder may be a linear encoder. For example, in a linear encoder, when there is a cause of periodic variation in the guide mechanism, by applying the correction value calculation process of the present embodiment, it is possible to calculate correction values while reducing periodic variations.

In each of the above embodiments, the case in which φ is obtained in the wide-range phase angle calculation unit 50 from the number of revolutions nᵢ of the Lissajous signal and the phase angle θ is described as an example, but φ may be obtained by other methods. For example, in an absolute encoder, φ may be obtained by absolute detection.

In the third embodiment described above, equal pitch data was used to evaluate the correction effectiveness, but when performing calculations using the least squares sinusoidal approximation, this can also be performed using unequal pitch data, and the same approximation accuracy as that obtained with equal pitch data can be achieved. In the case of unequal pitch data, position reference is not necessary, thus enabling autonomous self-calibration. Corrections were performed in the order of offset error, amplitude ratio error, phase difference error, 2nd harmonic error, and 5th harmonic error, but the items to be corrected and the order of correction are not limited to the above and are arbitrary.

In addition, in the first to third embodiments, corrections were not made for other harmonics such as the third, fourth, and sixth harmonics, but harmonics of any order (orders that tend to be included in 2-phase sinusoidal signals depending on the characteristics of the encoder and the environment in which the encoder is used) may be selected and corrected.

In the third embodiment, the amplitude normalization process using the amplitude normalization coefficient Kₓ to normalize the amplitude to 1 was divided into two stages. However, depending on the correction items, the target error, or the amplitude of the signals before normalization, both or either of the two amplitude normalization stages may be omitted.

Any additions, deletions, and design modifications of constituent elements in the embodiments which those skilled in the art could conceive of and any combinations of features of the embodiments can also fall within the scope of the present invention, as long as they contain the spirit of the present invention.

With respect to the above embodiments, the following appendices are further disclosed.

(Appendix 1) A correction value calculation method that calculates correction values to correct a kth harmonic component in 2-phase sinusoidal signals (X, Y) output by an encoder, comprising:
a polar coordinate calculation step for calculating, for N phase angles θᵢ and a Lissajous radii Rᵢ corresponding to each phase angle θᵢ in a Lissajous waveform drawn by the 2-phase sinusoidal signals, a squared radius Rᵢ², which is the square of the Lissajous radius Rᵢ corresponding to each phase angle θᵢ; and
a correction value calculation step for obtaining coefficients in an approximate expression model representing the squared radius R² of the 2-phase sinusoidal signals containing kth harmonic components based on phase angle θᵢ calculated in the polar coordinate calculation step and the squared radius Rᵢ² corresponding to each phase angle θᵢ, and obtaining the correction values from the obtained coefficients,
wherein in the correction value calculation step, the coefficients of the approximate expression model are determined by the least-squares method, and the resulting correction values are cumulatively added as correction residuals.
   (Appendix 2) The correction value calculation method according to Appendix 1, wherein in the correction value calculation step:
based on the phase angle θᵢ calculated by the polar coordinate calculation step and the squared radius Rᵢ² corresponding to the phase angle θᵢ, a correction residual ΔAₖₐ of a cosine amplitude Aₖₐ and a correction residual ΔA_{kb} of a sine amplitude A_{kb} are calculated, where the kth harmonic component contained in the 2-phase sinusoidal signals (X, Y) are expressed using Equations (11) and (12), and the cosine amplitude Aₖₐ and the sine amplitude A_{kb} are calculated based on each correction residual;

$${x}_{k} = + {A}_{ka} cos k θ - {A}_{k b} sin k θ \qquad ( 11 )$$

$${y}_{k} = ∓ {A}_{kb} cos k θ ∓ {A}_{ka} sin k θ \qquad ( 12 )$$

using Equation (16) as an approximate expression model for the squared radius R², coefficients A_{c(k±1)} and A_{s(k±1)} in Equation (16) are determined by the least squares method using phase angle (k±1)θᵢ and the squared radius Rᵢ² corresponding to the phase angle (k±1)θᵢ; and

$${R}^{2} = {R}_{o ( k \pm 1 )} + {A}_{c ( k \pm 1 )} cos ( k \pm 1 ) θ + {A}_{s ( k \pm 1 )} sin ( k \pm 1 ) θ \qquad ( 16 )$$

from the obtained coefficients A_{c(k±1)} and A_{s(k±1)}, the correction residual ΔAₖₐ of the cosine amplitude Aₖₐ and the correction residual ΔA_{kb} of the sine amplitude A_{kb} are obtained using Equation (21).

$$\begin{matrix}Δ {A}_{k a} = \frac{{A}_{c ( k \pm 1 )}}{2} \\ Δ {A}_{kb} = - \frac{{A}_{s ( k \pm 1 )}}{2}\end{matrix} \qquad ( 21 )$$

(Appendix 3) The correction value calculation method according to Appendix 2, wherein in the correction value calculation step, the coefficients A_{c(k±1)} and A_{s(k±1)} in Equation (16) are obtained as elements of the C_{(k±1)} matrix using Equation (17).

$$\begin{matrix}{A}_{( k \pm 1 )} = [ \begin{matrix}\sum {cos}^{2} ( k \pm 1 ) {θ}_{i} & \sum sin ( k \pm 1 ) {θ}_{i} cos ( k \pm 1 ) {θ}_{i} & \sum cos ( k \pm 1 ) {θ}_{i} \\ \sum cos ( k \pm 1 ) {θ}_{i} sin ( k \pm 1 ) {θ}_{i} & \sum {sin}^{2} ( k \pm 1 ) {θ}_{i} & \sum sin ( k \pm 1 ) {θ}_{i} \\ \sum cos ( k \pm 1 ) {θ}_{i} & \sum sin ( k \pm 1 ) {θ}_{i} & N\end{matrix} ] \\ {B}_{( k \pm 1 )} = [ \begin{matrix}\sum {R}_{i}^{2} cos ( k \pm 1 ) {θ}_{i} \\ \sum {R}_{i}^{2} sin ( k \pm 1 ) {θ}_{i} \\ \sum {R}_{i}^{2}\end{matrix} ] \\ {C}_{( k \pm 1 )} = [ \begin{matrix}{A}_{c ( k \pm 1 )} \\ {A}_{s ( k \pm 1 )} \\ {R}_{o ( k \pm 1 )}\end{matrix} ] \\ {A}_{( k \pm 1 )} \cdot {C}_{1 ( k \pm 1 )} = {B}_{( k \pm 1 )} \\ {C}_{( k \pm 1 )} = {A}_{( k \pm 1 )}^{- 1} \cdot {B}_{( k \pm 1 )}\end{matrix} \qquad ( 17 )$$

(Appendix 4) The correction value calculation method according to Appendix 2, wherein in the correction value calculation step, the coefficients A_{c(k±1)} and A_{s(k±1)} in Equation (16) are obtained as elements of the C_{(k±1)} matrix using Equations (43) to (45),

$$\begin{matrix}{A}_{( k \pm 1 )} = [ \begin{matrix}\sum {( {CS ( k \pm 1 )}_{i} )}^{2} & \sum ( {CS ( k \pm 1 )}_{i} ) ( {SN ( k \pm 1 )}_{i} ) & \sum ( {CS ( k \pm 1 )}_{i} ) \\ \sum ( {CS ( k \pm 1 )}_{i} ) ( {SN ( k \pm 1 )}_{i} ) & \sum {( {SN ( k \pm 1 )}_{i} )}^{2} & \sum ( {SN ( k \pm 1 )}_{i} ) \\ \sum ( {CS ( k \pm 1 )}_{i} ) & \sum ( {SN ( k \pm 1 )}_{i} ) & N\end{matrix} ] \\ {B}_{( k \pm 1 )} = [ \begin{matrix}\sum {R}_{i}^{2} ( {CS ( k \pm 1 )}_{i} ) \\ \sum {R}_{i}^{2} ( {SN ( k \pm 1 )}_{i} ) \\ \sum {R}_{i}^{2}\end{matrix} ] \\ {C}_{( k \pm 1 )} = [ \begin{matrix}{A}_{c ( k \pm 1 )} \\ {A}_{s ( k \pm 1 )} \\ {R}_{o ( k \pm 1 )}\end{matrix} ] \\ {A}_{( k \pm 1 )} \cdot {C}_{( k \pm 1 )} = {B}_{( k \pm 1 )} \\ {C}_{( k \pm 1 )} = {A}_{( k \pm 1 )}^{- 1} \cdot {B}_{( k \pm 1 )}\end{matrix} \qquad ( 43 )$$

$$\begin{matrix}cos ( k \pm 1 ) {θ}_{i} = {\sum }_{p = 0}^{[ ( k \pm 1 ) / 2 ]} \frac{{( - 1 )}^{p} ( k \pm 1 )}{2 ( k \pm 1 - p )} {}_{k \pm 1 - p} {C}_{p} {( 2 cos {θ}_{i} )}^{k \pm 1 - 2 p} \\ \approx {\sum }_{p = 0}^{[ ( k \pm 1 ) / 2 ]} \frac{{( - 1 )}^{p} ( k \pm 1 )}{2 ( k \pm 1 - p )} {}_{k \pm 1 - p} {C}_{p} {( 2 {X}_{i} )}^{k \pm 1 - 2 p} \\ ≡ {CS ( k \pm 1 )}_{i}\end{matrix} \qquad ( 44 )$$

$$\begin{matrix}sin ( k \pm 1 ) {θ}_{i} = sin θ {\sum }_{p = 0}^{[ ( k \pm 1 - 1 ) / 2 ]} {( - 1 )}^{p} {}_{k \pm 1 - p - 1} {C}_{p} {( 2 cos {θ}_{i} )}^{k \pm 1 - 2 p - 1} \\ \approx {Y}_{i} {\sum }_{p = 0}^{[ ( k \pm 1 - 1 ) / 2 ]} {( - 1 )}^{p} {}_{k \pm 1 - p - 1} {C}_{p} {( 2 {X}_{i} )}^{k \pm 1 - 2 p - 1} \\ ≡ {SN ( k \pm 1 )}_{i}\end{matrix} \qquad ( 45 )$$

where, in Equations (44) and (45), [x] is a Gaussian symbol representing the largest integer not exceeding X.
(Appendix 5) The correction value calculation method according to Appendix 4, further comprising a correction step for correcting the 2-phase sinusoidal signals based on the correction values,
wherein, in the correction step, the kth harmonics xₖᵢ and yₖᵢ are obtained using Equations (46) to (49),

$${x}_{ki} = {A}_{ka} {CSk}_{i} - {A}_{kb} {SNk}_{i} \qquad ( 46 )$$

$${y}_{ki} = ∓ {A}_{kb} {CSk}_{i} ∓ {A}_{ka} {SNk}_{i} \qquad ( 47 )$$

$$\begin{matrix}cos k {θ}_{i} = {\sum }_{p = 0}^{[ k / 2 ]} \frac{{( - 1 )}^{p} k}{2 ( k - p )} {}_{k - p} {C}_{p} {( 2 cos {θ}_{i} )}^{k - 2 p} \\ \approx {\sum }_{p = 0}^{[ k / 2 ]} \frac{{( - 1 )}^{p} k}{2 ( k - p )} {}_{k - p} {C}_{p} {( 2 {X}_{i} )}^{k - 2 p} ≡ {CSk}_{i}\end{matrix} \qquad ( 48 )$$

$$\begin{matrix}sin k {θ}_{i} = sin θ {\sum }_{p = 0}^{[ ( k - 1 ) / 2 ]} {( - 1 )}^{p} {}_{k - p - 1} {C}_{p} {( 2 cos {θ}_{i} )}^{k - 2 p - 1} \\ \approx {Y}_{i} {\sum }_{p = 0}^{[ ( k - 1 ) / 2 ]} {( - 1 )}^{p} {}_{k - p - 1} {C}_{p} {( 2 {X}_{i} )}^{k - 2 p - 1} ≡ {SNk}_{i}\end{matrix} \qquad ( 49 )$$

where, in Equations (48) and (49), [x] is a Gaussian symbol representing the largest integer not exceeding x, and
by subtracting the obtained xₖᵢ and yₖᵢ from the corresponding data of the 2-phase sinusoidal signals, the 2-phase sinusoidal signals are corrected.
   (Appendix 6) The correction value calculation method according to any one of Appendices 1 to 5, further comprising a correction step for correcting the 2-phase sinusoidal signals based on the correction values,
wherein the correction value calculation step is applied again to the 2-phase sinusoidal signals corrected by the correction step to update the correction values.
   (Appendix 7) The correction value calculation method according to Appendix 6, wherein the correction values are updated using Equation (22).

$$\begin{matrix}{A}_{k a} = {A}_{k a} + {G}_{f} \cdot Δ {A}_{k a} \\ {A}_{k b} = {A}_{k b} + {G}_{f} \cdot Δ {A}_{k b} \\ where 0 < {G}_{f} \leq 1 .\end{matrix} \qquad ( 22 )$$

(Appendix 8) A program that causes a computer to execute the correction value calculation method according to Appendix 1.
(Appendix 9) A correction value calculation apparatus for calculating correction values to correct 2-phase sinusoidal signals (X, Y) output by an encoder, comprising:
a polar coordinate conversion unit that calculates, for N phase angles θᵢ and Lissajous radii Rᵢ corresponding to each phase angle θᵢ in a Lissajous waveform drawn by the 2-phase sinusoidal signals, the squared radius Rᵢ², which is the square of the Lissajous radius Rᵢ corresponding to each phase angle θᵢ; and
an error detection unit for obtaining coefficients in an approximate expression model representing the squared radius R² of the 2-phase sinusoidal signals containing kth harmonic components based on phase angle θᵢ calculated by the polar coordinate conversion unit and the squared radius Rᵢ² corresponding to each phase angle θᵢ, and obtaining the correction values from the obtained coefficients,
wherein the error detection unit determines the coefficients of the approximate expression model by the least-squares method, and obtains the correction values by cumulatively adding the determined correction values as correction residuals.
   (Appendix 10) The correction value calculation apparatus according to Appendix 9, wherein the error detection unit:
calculates a correction residual ΔAₖₐ of a cosine amplitude Aₖₐ and a correction residual ΔA_{kb} of a sine amplitude A_{kb} based on the phase angle θᵢ calculated by the polar coordinate conversion unit and the squared radius Rᵢ² corresponding to the phase angle θᵢ, where the kth harmonic component contained in the 2-phase sinusoidal signals (X, Y) are expressed using Equations (11) and (12), and calcurates the cosine amplitude Aₖₐ and the sine amplitude A_{kb} based on each correction residual;

$${x}_{k} = + {A}_{ka} cos k θ - {A}_{k b} sin k θ \qquad ( 11 )$$

$${y}_{k} = ∓ {A}_{kb} cos k θ ∓ {A}_{ka} sin k θ \qquad ( 12 )$$

using Equation (16) as an approximate expression model for the squared radius R², determines coefficients A_{c(k±1)} and A_{s(k±1)} in Equation (16) by the least squares method using phase angle (k±1)θᵢ and the squared radius Rᵢ² corresponding to phase angle (k±1)θᵢ; and

$${R}^{2} = {R}_{o ( k \pm 1 )} + {A}_{c ( k \pm 1 )} cos ( k \pm 1 ) θ + {A}_{s ( k \pm 1 )} sin ( k \pm 1 ) θ \qquad ( 16 )$$

from the obtained coefficients A_{c(k±1)} and A_{s(k±1)}, obtains the correction residual ΔAₖₐ of the cosine amplitude Aₖₐ and the correction residual ΔA_{kb} of the sine amplitude A_{kb} using Equation (21).

$$\begin{matrix}Δ {A}_{k a} = \frac{{A}_{c ( k \pm 1 )}}{2} \\ Δ {A}_{kb} = - \frac{{A}_{s ( k \pm 1 )}}{2}\end{matrix} \qquad ( 21 )$$

(Appendix 11) The correction value calculation apparatus according to Appendix 10, wherein the error detection unit obtains the coefficients A_{c(k±1)} and A_{s(k±1)} in Equation (16) as elements of the C_{(k±1)} matrix using Equation (17).

$$\begin{matrix}{A}_{( k \pm 1 )} = [ \begin{matrix}\sum {cos}^{2} ( k \pm 1 ) {θ}_{i} & \sum sin ( k \pm 1 ) {θ}_{i} cos ( k \pm 1 ) {θ}_{i} & \sum cos ( k \pm 1 ) {θ}_{i} \\ \sum cos ( k \pm 1 ) {θ}_{i} sin ( k \pm 1 ) {θ}_{i} & \sum {sin}^{2} ( k \pm 1 ) {θ}_{i} & \sum sin ( k \pm 1 ) {θ}_{i} \\ \sum cos ( k \pm 1 ) {θ}_{i} & \sum sin ( k \pm 1 ) {θ}_{i} & N\end{matrix} ] \\ {B}_{( k \pm 1 )} = [ \begin{matrix}\sum {R}_{i}^{2} cos ( k \pm 1 ) {θ}_{i} \\ \sum {R}_{i}^{2} sin ( k \pm 1 ) {θ}_{i} \\ \sum {R}_{i}^{2}\end{matrix} ] \\ {C}_{( k \pm 1 )} = [ \begin{matrix}{A}_{c ( k \pm 1 )} \\ {A}_{s ( k \pm 1 )} \\ {R}_{o ( k \pm 1 )}\end{matrix} ] \\ {A}_{( k \pm 1 )} \cdot {C}_{1 ( k \pm 1 )} = {B}_{( k \pm 1 )} \\ {C}_{( k \pm 1 )} = {A}_{( k \pm 1 )}^{- 1} \cdot {B}_{( k \pm 1 )}\end{matrix} \qquad ( 17 )$$

(Appendix 12) The correction value calculation apparatus according to Appendix 10, wherein the error detection unit obtains the coefficients A_{c(k±1)} and A_{s(k±1)} in Equation (16) as elements of the C_{(k±1)} matrix using Equations (43) to (45),

$$\begin{matrix}{A}_{( k \pm 1 )} = [ \begin{matrix}\sum {( {CS ( k \pm 1 )}_{i} )}^{2} & \sum ( {CS ( k \pm 1 )}_{i} ) ( {SN ( k \pm 1 )}_{i} ) & \sum ( {CS ( k \pm 1 )}_{i} ) \\ \sum ( {CS ( k \pm 1 )}_{i} ) ( {SN ( k \pm 1 )}_{i} ) & \sum {( {SN ( k \pm 1 )}_{i} )}^{2} & \sum ( {SN ( k \pm 1 )}_{i} ) \\ \sum ( {CS ( k \pm 1 )}_{i} ) & \sum ( {SN ( k \pm 1 )}_{i} ) & N\end{matrix} ] \\ {B}_{( k \pm 1 )} = [ \begin{matrix}\sum {R}_{i}^{2} ( {CS ( k \pm 1 )}_{i} ) \\ \sum {R}_{i}^{2} ( {SN ( k \pm 1 )}_{i} ) \\ \sum {R}_{i}^{2}\end{matrix} ] \\ {C}_{( k \pm 1 )} = [ \begin{matrix}{A}_{c ( k \pm 1 )} \\ {A}_{s ( k \pm 1 )} \\ {R}_{o ( k \pm 1 )}\end{matrix} ] \\ {A}_{( k \pm 1 )} \cdot {C}_{( k \pm 1 )} = {B}_{( k \pm 1 )} \\ {C}_{( k \pm 1 )} = {A}_{( k \pm 1 )}^{- 1} \cdot {B}_{( k \pm 1 )}\end{matrix} \qquad ( 43 )$$

$$\begin{matrix}cos ( k \pm 1 ) {θ}_{i} = {\sum }_{p = 0}^{[ ( k \pm 1 ) / 2 ]} \frac{{( - 1 )}^{p} ( k \pm 1 )}{2 ( k \pm 1 - p )} {}_{k \pm 1 - p} {C}_{p} {( 2 cos {θ}_{i} )}^{k \pm 1 - 2 p} \\ \approx {\sum }_{p = 0}^{[ ( k \pm 1 ) / 2 ]} \frac{{( - 1 )}^{p} ( k \pm 1 )}{2 ( k \pm 1 - p )} {}_{k \pm 1 - p} {C}_{p} {( 2 {X}_{i} )}^{k \pm 1 - 2 p} \\ ≡ {CS ( k \pm 1 )}_{i}\end{matrix} \qquad ( 44 )$$

$$\begin{matrix}sin ( k \pm 1 ) {θ}_{i} = sin θ {\sum }_{p = 0}^{[ ( k \pm 1 - 1 ) / 2 ]} {( - 1 )}^{p} {}_{k \pm 1 - p - 1} {C}_{p} {( 2 cos {θ}_{i} )}^{k \pm 1 - 2 p - 1} \\ \approx {Y}_{i} {\sum }_{p = 0}^{[ ( k \pm 1 - 1 ) / 2 ]} {( - 1 )}^{p} {}_{k \pm 1 - p - 1} {C}_{p} {( 2 {X}_{i} )}^{k \pm 1 - 2 p - 1} \\ ≡ {SN ( k \pm 1 )}_{i}\end{matrix} \qquad ( 45 )$$

where, in Equations (44) and (45), [x] is a Gaussian symbol representing the largest integer not exceeding X.
(Appendix 13) The correction value calculation apparatus according to Appendix 10, further comprising a correction unit that corrects the 2-phase sinusoidal signals based on the correction values,
wherein the correction unit:
obtains the kth harmonics xₖᵢ and yₖᵢ using Equations (46) to (49),

$${x}_{ki} = {A}_{ka} {CSk}_{i} - {A}_{kb} {SNk}_{i} \qquad ( 46 )$$

$${y}_{ki} = ∓ {A}_{kb} {CSk}_{i} ∓ {A}_{ka} {SNk}_{i} \qquad ( 47 )$$

$$\begin{matrix}cos k {θ}_{i} = {\sum }_{p = 0}^{[ k / 2 ]} \frac{{( - 1 )}^{p} k}{2 ( k - p )} {}_{k - p} {C}_{p} {( 2 cos {θ}_{i} )}^{k - 2 p} \\ \approx {\sum }_{p = 0}^{[ k / 2 ]} \frac{{( - 1 )}^{p} k}{2 ( k - p )} {}_{k - p} {C}_{p} {( 2 {X}_{i} )}^{k - 2 p} ≡ {CSk}_{i}\end{matrix} \qquad ( 48 )$$

$$\begin{matrix}sin k {θ}_{i} = sin θ {\sum }_{p = 0}^{[ ( k - 1 ) / 2 ]} {( - 1 )}^{p} {}_{k - p - 1} {C}_{p} {( 2 cos {θ}_{i} )}^{k - 2 p - 1} \\ \approx {Y}_{i} {\sum }_{p = 0}^{[ ( k - 1 ) / 2 ]} {( - 1 )}^{p} {}_{k - p - 1} {C}_{p} {( 2 {X}_{i} )}^{k - 2 p - 1} ≡ {SNk}_{i}\end{matrix} \qquad ( 49 )$$

where, in Equations (48) and (49), [x] is a Gaussian symbol representing the largest integer not exceeding x; and
corrects the 2-phase sinusoidal signals by subtracting the obtained xₖᵢ and yₖᵢ from the corresponding data of the 2-phase sinusoidal signals.
   (Appendix 14) The correction value calculation apparatus according to Appendix 10, further comprising a correction unit that corrects the 2-phase sinusoidal signals based on the correction values,
wherein the polar coordinate conversion unit calculates squared radius R², which is the square of the Lissajous radius R corresponding to each phase angle θ, for the 2-phase sinusoidal signals corrected by the correction unit, and
the error detection unit calculates new correction values based on each phase angle θ and the squared radius R² calculated by the polar coordinate conversion unit, and updates the correction values.
   (Appendix 15) The correction value calculation apparatus according to Appendix 14, wherein the error detection unit updates the correction values using Equation (22).

$${A}_{ka} = {A}_{ka} + {G}_{f} \cdot Δ {A}_{ka} \qquad ( 22 )$$

$${A}_{kb} = {A}_{kb} + {G}_{f} \cdot Δ {A}_{kb}$$

$$where 0 < {G}_{f} \leq 1 ,$$

(Appendix 16) An encoder comprising: the correction value calculation apparatus according to any one of Appendices 9 to 15; and
an encoder detection unit that outputs 2-phase sinusoidal signals in response to displacement along the measurement direction,
wherein the correction value calculation apparatus performs:
a correction value calculation process that calculates correction values based on the 2-phase sinusoidal signals output by the encoder detection unit; and
a correction process that applies the calculated correction values to the 2-phase sinusoidal signals output by the encoder detection unit.

1. A correction value calculation method that calculates correction values to correct the kth harmonic component in 2-phase sinusoidal signals (X, Y) output by the encoder, comprising:
a polar coordinate calculation step for calculating, for N phase angles θᵢ and Lissajous radii Rᵢ corresponding to each phase angle θᵢ in a Lissajous waveform drawn by the 2-phase sinusoidal signals, a squared radius Rᵢ², which is the square of the Lissajous radius Rᵢ corresponding to each phase angle θᵢ; and
a correction value calculation step for obtaining coefficients in an approximate expression model representing the squared radius R² of the 2-phase sinusoidal signals containing kth harmonic components based on phase angle θᵢ calculated in the polar coordinate calculation step and the squared radius Rᵢ² corresponding to each phase angle θᵢ, and obtaining the correction values from the obtained coefficients,
wherein in the correction value calculation step, the coefficients of the approximate expression model are determined by the least-squares method, and the resulting correction values are cumulatively added as correction residuals.

2. The correction value calculation method according to claim 1,
wherein, in the correction value calculation step:
based on the phase angle θᵢ calculated by the polar coordinate calculation step and the squared radius Rᵢ² corresponding to the phase angle θᵢ, a correction residual ΔAₖₐ of a cosine amplitude Aₖₐ and a correction residual ΔA_{kb} of a sine amplitude A_{kb} are calculated, where the kth harmonic component contained in the 2-phase sinusoidal signals (X, Y) are expressed using Equations (11) and (12), and the cosine amplitude Aₖₐ and the sine amplitude A_{kb} are calculated based on each correction residual;
$${x}_{k} = + {A}_{ka} cos k θ - {A}_{kb} sin k θ \qquad ( 11 )$$
$${y}_{k} = ∓ {A}_{kb} cos k θ ∓ {A}_{ka} sin k θ \qquad ( 12 )$$
using Equation (16) as an approximate expression model for the squared radius R², the coefficients A_{c(k±1)} and A_{s(k±1)} in Equation (16) are determined by the least squares method using each phase angle (k±1)θᵢ and the squared radius Rᵢ² corresponding to the phase angle (k±1)θᵢ; and
$${R}^{2} = {R}_{o ( k \pm 1 )} + {A}_{c ( k \pm 1 )} cos ( k \pm 1 ) θ + {A}_{s ( k \pm 1 )} sin ( k \pm 1 ) θ \qquad ( 16 )$$
from the obtained coefficients A_{c(k±1)} and A_{s(k±1)}, the correction residual ΔAₖₐ of the cosine amplitude Aₖₐ and the correction residual ΔA_{kb} of the sine amplitude A_{kb} are obtained using Equation (21)
$$Δ {A}_{ka} = \frac{{A}_{c ( k \pm 1 )}}{2} \qquad ( 21 )$$
$$Δ {A}_{kb} = - \frac{{A}_{s ( k \pm 1 )}}{2} .$$

3. The correction value calculation method according to claim 2, wherein
in the correction value calculation step,
the coefficients A_{c(k±1)} and A_{s(k±1)} in Equation (16) are obtained as elements of the C_{(k±1)} matrix using Equation (17)
$${A}_{( k \pm 1 )} = [ \begin{matrix}\sum {cos}^{2} ( k \pm 1 ) {θ}_{i} & \sum sin ( k \pm 1 ) {θ}_{i} cos ( k \pm 1 ) {θ}_{i} & \sum cos ( k \pm 1 ) {θ}_{i} \\ \sum cos ( k \pm 1 ) {θ}_{i} sin ( k \pm 1 ) {θ}_{i} & \sum {sin}^{2} ( k \pm 1 ) {θ}_{i} & \sum sin ( k \pm 1 ) {θ}_{i} \\ \sum cos ( k \pm 1 ) {θ}_{i} & \sum sin ( k \pm 1 ) {θ}_{i} & N\end{matrix} ] \qquad ( 17 )$$
$${B}_{( k \pm 1 )} = [ \begin{matrix}\sum {R}_{i}^{2} cos ( k \pm 1 ) {θ}_{i} \\ \sum {R}_{i}^{2} sin ( k \pm 1 ) {θ}_{i} \\ \sum {R}_{i}^{2}\end{matrix} ]$$
$${C}_{( k \pm 1 )} = [ \begin{matrix}{A}_{c ( k \pm 1 )} \\ {A}_{s ( k \pm 1 )} \\ {R}_{o ( k \pm 1 )}\end{matrix} ]$$
$${A}_{( k \pm 1 )} \cdot {C}_{1 ( k \pm 1 )} = {B}_{( k \pm 1 )}$$
$${C}_{( k \pm 1 )} = {A}_{( k \pm 1 )}^{- 1} \cdot {B}_{( k \pm 1 )} .$$

4. The correction value calculation method according to claim 2, wherein, in the correction value calculation step, the coefficients A_{c(k±1)} and A_{s(k±1)} in Equation (16) are obtained as elements of the C_{(k±1)} matrix using Equations (43) to (45),
$${A}_{( k \pm 1 )} = [ \begin{matrix}\sum {( {CS ( k \pm 1 )}_{i} )}^{2} & \sum ( {CS ( k \pm 1 )}_{i} ) ( {SN ( k \pm 1 )}_{i} ) & \sum ( {CS ( k \pm 1 )}_{i} ) \\ \sum ( {CS ( k \pm 1 )}_{i} ) ( {SN ( k \pm 1 )}_{i} ) & \sum {( {SN ( k \pm 1 )}_{i} )}^{2} & \sum ( {SN ( k \pm 1 )}_{i} ) \\ \sum ( {CS ( k \pm 1 )}_{i} ) & \sum ( {SN ( k \pm 1 )}_{i} ) & N\end{matrix} ] \qquad ( 43 )$$
$${B}_{( k \pm 1 )} = [ \begin{matrix}\sum {R}_{i}^{2} ( {CS ( k \pm 1 )}_{i} ) \\ \sum {R}_{i}^{2} ( {SN ( k \pm 1 )}_{i} ) \\ \sum {R}_{i}^{2}\end{matrix} ]$$
$${C}_{( k \pm 1 )} = [ \begin{matrix}{A}_{c ( k \pm 1 )} \\ {A}_{s ( k \pm 1 )} \\ {R}_{o ( k \pm 1 )}\end{matrix} ]$$
$${A}_{( k \pm 1 )} \cdot {C}_{( k \pm 1 )} = {B}_{( k \pm 1 )}$$
$${C}_{( k \pm 1 )} = {A}_{( k \pm 1 )}^{- 1} \cdot {B}_{( k \pm 1 )}$$
$$cos ( k \pm 1 ) {θ}_{i} = {\sum }_{p = 0}^{[ ( k \pm 1 ) / 2 ]} {\frac{{( - 1 )}^{p} ( k \pm 1 )}{2 ( k \pm 1 - p )}}_{k \pm 1 - p} {{C}_{p} ( 2 cos {θ}_{i} )}^{k \pm 1 - 2 p} \approx {\sum }_{p = 0}^{[ ( k \pm 1 ) / 2 ]} {\frac{{( - 1 )}^{p} ( k \pm 1 )}{2 ( k \pm 1 - p )}}_{k \pm 1 - p} {{C}_{p} ( 2 {X}_{i} )}^{k \pm 1 - 2 p} ≡ {CS ( k \pm 1 )}_{i} \qquad ( 44 )$$
$$sin ( k \pm 1 ) {θ}_{i} = sin θ {\sum }_{p = 0}^{[ ( k \pm 1 - 1 ) / 2 ]} {{( - 1 )}^{p}}_{k \pm 1 - p - 1} {{C}_{p} ( 2 cos {θ}_{i} )}^{k \pm 1 - 2 p - 1} \approx {Y}_{i} {\sum }_{p = 0}^{[ ( k \pm 1 - 1 ) / 2 ]} {{( - 1 )}^{p}}_{k \pm 1 - p - 1} {{C}_{p} ( 2 {X}_{i} )}^{k \pm 1 - 2 p - 1} ≡ {SN ( k \pm 1 )}_{i} \qquad ( 45 )$$
where, in Equations (44) and (45), [x] is a Gaussian symbol representing the largest integer not exceeding X.

5. The correction value calculation method according to claim 4, further comprising a correction step for correcting the 2-phase sinusoidal signals based on the correction values,
wherein, in the correction step, the kth harmonics xₖᵢ and yₖᵢ are obtained using Equations (46) to (49),
$${x}_{ki} = {A}_{ka} {CSk}_{i} - {A}_{kb} {SNk}_{i} \qquad ( 46 )$$
$${y}_{ki} = ∓ {A}_{kb} {CSk}_{i} ∓ {A}_{ka} {SNk}_{i} \qquad ( 47 )$$
$$cos k {θ}_{i} = {\sum }_{p = 0}^{[ k / 2 ]} {\frac{{( - 1 )}^{p} k}{2 ( k - p )}}_{k - p} {{C}_{p} ( 2 cos {θ}_{i} )}^{k - 2 p} \approx {\sum }_{p = 0}^{[ k / 2 ]} {\frac{{( - 1 )}^{p} k}{2 ( k - p )}}_{k - p} {{C}_{p} ( 2 {X}_{i} )}^{k - 2 p} ≡ {CSk}_{i} \qquad ( 48 )$$
$$sin k {θ}_{i} = sin θ {\sum }_{p = 0}^{[ ( k - 1 ) / 2 ]} {( - 1 )}_{k - p - 1}^{p} {{C}_{p} ( 2 cos {θ}_{i} )}^{k - 2 p - 1} \approx {Y}_{i} {\sum }_{p = 0}^{[ ( k - 1 ) / 2 ]} {( - 1 )}_{k - p - 1}^{p} {{C}_{p} ( 2 {X}_{i} )}^{k - 2 p - 1} ≡ {SNk}_{i} \qquad ( 49 )$$
where, in Equations (48) and (49), [x] is a Gaussian symbol representing the largest integer not exceeding x, and
by subtracting the obtained xₖᵢ and yₖᵢ from the corresponding data of the 2-phase sinusoidal signals, the 2-phase sinusoidal signals are corrected.

6. The correction value calculation method according to claim 1, further comprising a correction step for correcting the 2-phase sinusoidal signals based on the correction values,
wherein the correction value calculation step is applied again to the 2-phase sinusoidal signals corrected by the correction step to update the correction values.

7. The correction value calculation method according to claim 6, wherein the correction values are updated using Equation (22)
$${A}_{ka} = {A}_{ka} + {G}_{f} \cdot Δ {A}_{ka} \qquad ( 22 )$$
$${A}_{kb} = {A}_{kb} + {G}_{f} \cdot Δ {A}_{kb}$$
$$where 0 < {G}_{f} \leq 1.$$

8. A program that causes a computer to execute the correction value calculation method as claimed in claim 1.

9. A correction value calculation apparatus for calculating correction values to correct the 2-phase sinusoidal signals (X, Y) output by the encoder, comprising:
a polar coordinate conversion unit that calculates, for N phase angles θᵢ and the Lissajous radii Rᵢ corresponding to each phase angle θᵢ in a Lissajous waveform drawn by the 2-phase sinusoidal signals, the squared radius Rᵢ², which is the square of the Lissajous radius Rᵢ corresponding to each phase angle θᵢ; and
an error detection unit for obtaining coefficients in an approximate expression model representing the squared radius R² of the 2-phase sinusoidal signals containing kth harmonic components based on phase angle θᵢ calculated by the polar coordinate conversion unit and the squared radius Rᵢ² corresponding to each phase angle θᵢ, and obtaining the correction values from the obtained coefficients,
wherein the error detection unit determines the coefficients of the approximate expression model by the least-squares method, and obtains the correction values by cumulatively adding the determined correction values as correction residuals.

10. The correction value calculation apparatus according to claim 9, wherein the error detection unit:
calculates a correction residual ΔAₖₐ of a cosine amplitude Aₖₐ and a correction residual ΔA_{kb} of a sine amplitude A_{kb} based on the phase angle θᵢ calculated by the polar coordinate conversion unit and the squared radius Rᵢ² corresponding to the phase angle θᵢ, where the kth harmonic components contained in the 2-phase sinusoidal signals (X, Y) are expressed using Equations (11) and (12), and calculates the cosine amplitude Aₖₐ and the sine amplitude A_{kb} based on each correction residual;
$${x}_{k} = + {A}_{ka} cos k θ - {A}_{kb} sin k θ \qquad ( 11 )$$
$${y}_{k} = ∓ {A}_{kb} cos k θ ∓ {A}_{ka} sin k θ \qquad ( 12 )$$
using Equation (16) as an approximate expression model for the squared radius R², determines coefficients A_{c(k±1)} and A_{s(k±1)} in Equation (16) by the least squares method using phase angle (k±1)θᵢ and the squared radius Rᵢ² corresponding to phase angle (k±1)θᵢ; and
$${R}^{2} = {R}_{o ( k \pm 1 )} + {A}_{c ( k \pm 1 )} cos ( k \pm 1 ) θ + {A}_{s ( k \pm 1 )} sin ( k \pm 1 ) θ \qquad ( 16 )$$
from the obtained coefficients A_{c(k±1)} and A_{s(k±1)}, obtains the correction residual ΔAₖₐ of the cosine amplitude Aₖₐ and the correction residual ΔA_{kb} of the sine amplitude A_{kb} using Equation (21)
$$Δ {A}_{ka} = \frac{{A}_{c ( k \pm 1 )}}{2} \qquad ( 21 )$$
$$Δ {A}_{kb} = - \frac{{A}_{s ( k \pm 1 )}}{2} .$$

11. The correction value calculation apparatus according to claim 10, wherein the error detection unit obtains the coefficients A_{c(k±1)} and A_{s(k±1)} in Equation (16) as elements of the C_{(k±1)} matrix using Equation (17).
$${A}_{( k \pm 1 )} = [ \begin{matrix}\sum {cos}^{2} ( k \pm 1 ) {θ}_{i} & \sum sin ( k \pm 1 ) {θ}_{i} cos ( k \pm 1 ) {θ}_{i} & \sum cos ( k \pm 1 ) {θ}_{i} \\ \sum cos ( k \pm 1 ) {θ}_{i} sin ( k \pm 1 ) {θ}_{i} & \sum {sin}^{2} ( k \pm 1 ) {θ}_{i} & \sum sin ( k \pm 1 ) {θ}_{i} \\ \sum cos ( k \pm 1 ) {θ}_{i} & \sum sin ( k \pm 1 ) {θ}_{i} & N\end{matrix} ] \qquad ( 17 )$$
$${B}_{( k \pm 1 )} = [ \begin{matrix}\sum {R}_{i}^{2} cos ( k \pm 1 ) {θ}_{i} \\ \sum {R}_{i}^{2} sin ( k \pm 1 ) {θ}_{i} \\ \sum {R}_{i}^{2}\end{matrix} ]$$
$${C}_{( k \pm 1 )} = [ \begin{matrix}{A}_{c ( k \pm 1 )} \\ {A}_{s ( k \pm 1 )} \\ {R}_{o ( k \pm 1 )}\end{matrix} ]$$
$${A}_{( k \pm 1 )} \cdot {C}_{1 ( k \pm 1 )} = {B}_{( k \pm 1 )}$$
$${C}_{( k \pm 1 )} = {A}_{( k \pm 1 )}^{- 1} \cdot {B}_{( k \pm 1 )} .$$

12. The correction value calculation apparatus according to claim 10, wherein the error detection unit obtains the coefficients A_{c2} and Aₛ₂ in Equation (16) as elements of the C matrix using Equations (43) to (45),
$${A}_{( k \pm 1 )} = [ \begin{matrix}\sum {( {CS ( k \pm 1 )}_{i} )}^{2} & \sum ( {CS ( k \pm 1 )}_{i} ) ( {SN ( k \pm 1 )}_{i} ) & \sum ( {CS ( k \pm 1 )}_{i} ) \\ \sum ( {CS ( k \pm 1 )}_{i} ) ( {SN ( k \pm 1 )}_{i} ) & \sum {( {SN ( k \pm 1 )}_{i} )}^{2} & \sum ( {SN ( k \pm 1 )}_{i} ) \\ \sum ( {CS ( k \pm 1 )}_{i} ) & \sum ( {SN ( k \pm 1 )}_{i} ) & N\end{matrix} ] \qquad ( 43 )$$
$${B}_{( k \pm 1 )} = [ \begin{matrix}\sum {R}_{i}^{2} ( {CS ( k \pm 1 )}_{i} ) \\ \sum {R}_{i}^{2} ( {SN ( k \pm 1 )}_{i} ) \\ \sum {R}_{i}^{2}\end{matrix} ]$$
$${C}_{( k \pm 1 )} = [ \begin{matrix}{A}_{c ( k \pm 1 )} \\ {A}_{s ( k \pm 1 )} \\ {R}_{o ( k \pm 1 )}\end{matrix} ]$$
$${A}_{( k \pm 1 )} \cdot {C}_{( k \pm 1 )} = {B}_{( k \pm 1 )}$$
$${C}_{( k \pm 1 )} = {A}_{( k \pm 1 )}^{- 1} \cdot {B}_{( k \pm 1 )}$$
$$cos ( k \pm 1 ) {θ}_{i} = {\sum }_{p = 0}^{[ ( k \pm 1 ) / 2 ]} {\frac{{( - 1 )}^{p} ( k \pm 1 )}{2 ( k \pm 1 - p )}}_{k \pm 1 - p} {{C}_{p} ( 2 cos {θ}_{i} )}^{k \pm 1 - 2 p} \approx {\sum }_{p = 0}^{[ ( k \pm 1 ) / 2 ]} {\frac{{( - 1 )}^{p} ( k \pm 1 )}{2 ( k \pm 1 - p )}}_{k \pm 1 - p} {{C}_{p} ( 2 {X}_{i} )}^{k \pm 1 - 2 p} ≡ {CS ( k \pm 1 )}_{i} \qquad ( 44 )$$
$$sin ( k \pm 1 ) {θ}_{i} = sin θ {\sum }_{p = 0}^{[ ( k \pm 1 - 1 ) / 2 ]} {{( - 1 )}^{p}}_{k \pm 1 - p - 1} {{C}_{p} ( 2 cos {θ}_{i} )}^{k \pm 1 - 2 p - 1} \approx {Y}_{i} {\sum }_{p = 0}^{[ ( k \pm 1 - 1 ) / 2 ]} {{( - 1 )}^{p}}_{k \pm 1 - p - 1} {{C}_{p} ( 2 {X}_{i} )}^{k \pm 1 - 2 p - 1} ≡ {SN ( k \pm 1 )}_{i} \qquad ( 45 )$$
where, in Equations (44) and (45), [x] is a Gaussian symbol representing the largest integer not exceeding X.

13. The correction value calculation apparatus according to claim 12, further comprising a correction unit that corrects the 2-phase sinusoidal signals based on the correction values,
wherein, in the correction unit:
obtains the kth harmonics xₖᵢ and yₖᵢ using Equations (46) to (49),
$${x}_{ki} = {A}_{ka} {CSk}_{i} - {A}_{kb} {SNk}_{i} \qquad ( 46 )$$
$${y}_{ki} = ∓ {A}_{kb} {CSk}_{i} ∓ {A}_{ka} {SNk}_{i} \qquad ( 47 )$$
$$cos k {θ}_{i} = {\sum }_{p = 0}^{[ k / 2 ]} {\frac{{( - 1 )}^{p} k}{2 ( k - p )}}_{k - p} {{C}_{p} ( 2 cos {θ}_{i} )}^{k - 2 p} \approx {\sum }_{p = 0}^{[ k / 2 ]} {\frac{{( - 1 )}^{p} k}{2 ( k - p )}}_{k - p} {{C}_{p} ( 2 {X}_{i} )}^{k - 2 p} ≡ {CSk}_{i} \qquad ( 48 )$$
$$sin k {θ}_{i} = sin θ {\sum }_{p = 0}^{[ ( k - 1 ) / 2 ]} {{( - 1 )}^{p}}_{k - p - 1} {{C}_{p} ( 2 cos {θ}_{i} )}^{k - 2 p - 1} \approx {Y}_{i} {\sum }_{p = 0}^{[ ( k - 1 ) / 2 ]} {( - 1 )}_{k - p - 1}^{p} {{C}_{p} ( 2 {X}_{i} )}^{k - 2 p - 1} ≡ {SNk}_{i} \qquad ( 49 )$$
where, in Equations (48) and (49), [x] is a Gaussian symbol representing the largest integer not exceeding x; and
corrects the 2-phase sinusoidal signals by subtracting the obtained xₖᵢ and yₖᵢ from the corresponding data of the 2-phase sinusoidal signals.

14. The correction value calculation apparatus according to claim 9, further comprising a correction unit that corrects the 2-phase sinusoidal signals based on the correction values,
wherein the polar coordinate conversion unit calculates squared radius R², which is the square of the Lissajous radius R corresponding to each phase angle θ, for the 2-phase sinusoidal signals corrected by the correction unit, and
the error detection unit calculates new correction values based on each phase angle θ and the squared radius R² calculated by the polar coordinate conversion unit, and updates the correction values.

15. The correction value calculation apparatus according to claim 14, wherein the error detection unit updates the correction values using Equation (22).
$${A}_{ka} = {A}_{ka} + {G}_{f} \cdot Δ {A}_{ka} \qquad ( 22 )$$
$${A}_{kb} = {A}_{kb} + {G}_{f} \cdot Δ {A}_{kb}$$
$$where 0 < {G}_{f} \leq 1.$$

16. An encoder comprising:
the correction value calculation apparatus as claimed in claim 9; and
an encoder detection unit that outputs 2-phase sinusoidal signals in response to displacement along the measurement direction,
wherein the correction value calculation apparatus performs:
a correction value calculation process that calculates correction values based on the 2-phase sinusoidal signals output by the encoder detection unit; and
a correction process that applies the calculated correction values to the 2-phase sinusoidal signals output by the encoder detection unit.
